(19) United States
(12) Patent Application Publication
(10) Pub. No.: US 2018/0281361 A1
(43) Pub. Date: Oct. 4, 2018

(54) LAMINATE FILM FOR TEMPORARY BONDING, METHODS FOR PRODUCING SUBSTRATE WORKPIECE AND LAMINATE SUBSTRATE WORKPIECE USING THE LAMINATE FILM FOR TEMPORARY BONDING, AND METHOD FOR PRODUCING SEMICONDUCTOR DEVICE USING THE SAME

(71) Applicant: TORAY INDUSTRIES, INC., Tokyo (JP)

(72) Inventors: Takuro ODA, Otsu-shi, Shiga (JP); Shinji ARIMOTO, Otsu-shi, Shiga (JP); Takenori FUJIWARA, Otsu-shi, Shiga (JP)

(73) Assignee: TORAY INDUSTRIES, INC., Tokyo (JP)

(21) Appl. No.: 15/767,552

(22) PCT Filed: Oct. 24, 2016
(86) PCT No.: PCT/JP2016/081420

§ 371 Date: Apr. 11, 2018

(30) Foreign Application Priority Data
Oct. 29, 2015 (JP) 2015-212600

(51) Int. Cl. B32B 27/08; B32B 27/28; C09J 183/04; C09J 179/08; C09J 11/04; C09J 7/22

(52) U.S. Cl. CPC B32B 27/08; B32B 27/283; B32B 27/281; C09J 7/22; C09J 179/08; C09J 11/04; C09J 183/04

(57) ABSTRACT

The present invention provides a laminate film for temporary bonding which is excellent in heat resistance, capable of providing a flat film even at the periphery of a substrate, and capable of making a semiconductor circuit formation substrate and a support substrate or a support film layer adhere to each other with one type of adhesive, and which can be peeled off at room temperature under mild conditions. The present invention provides a laminate film for temporary bonding, including at least three layers of (A) a protective film layer, (B) an adhesive layer, and (C) a support film layer, wherein the adhesive layer (B) contains at least a siloxane polymer represented by a specific general formula or a compound represented by a specific general formula.

### TECHNICAL FIELD

The present invention relates to a laminate film for temporary bonding, methods for producing a substrate workpiece and a laminate substrate workpiece using the laminate film for temporary bonding, and a method for producing a semiconductor device using the same.

### BACKGROUND ART

In recent years, semiconductor devices are increasingly reduced in weight and thickness. Techniques of laminating semiconductor chips while connecting the semiconductor chips with a through-silicon via (TSV) have been developed in order to achieve higher levels of integration and higher packaging density of semiconductor elements. Further, in the field of power semiconductors, reduction of conduction loss is required for energy saving. In order to achieve such an object, the thickness of the package has to be reduced. Thus, investigations have been made to reduce the thickness of a semiconductor circuit formation substrate to 100 μm or less and process the semiconductor circuit formation substrate. In this process, a surface of the semiconductor circuit formation substrate not having a circuit (backside) is polished to be thinned, and a back electrode is formed on the backside. In order to prevent fractures of the semiconductor circuit formation substrate during the steps of polishing and the like, the semiconductor circuit formation substrate is fixed to a support substrate having supporting properties, such as a silicon wafer or a glass substrate, and subjected to polishing, back circuit formation processing and the like, and then the processed semiconductor circuit formation substrate is peeled off from the support substrate. For fixing the semiconductor circuit formation substrate to the support substrate, an adhesive for temporary bonding is used. An adhesive used as the adhesive for temporary bonding is required to have heat resistance to withstand the heat load in the semiconductor circuit forming step, and is also required to be easily peeled off after completion of the processing step.

As such an adhesive for temporary bonding, for example, there has been proposed an adhesive which produces a polyamide- or polyimide-based heat-resistant adhesive layer, and which is peeled off by heating for varying the adhesive force (see, for example, Patent Document 1). There has also been proposed an adhesive for temporary bonding which produces a structure including two types of heat-resistant adhesive layers, that is, a thermoplastic organopolysiloxane-based adhesive layer and a curable modified siloxane-based adhesive layer, which has an adhesive force that makes the adhesive layer peelable from both a semiconductor circuit formation substrate and a support substrate, and which is peeled off by a mechanical force applied at room temperature (for example, Patent Document 2). There has also been proposed an adhesive for temporary bonding which produces a single type of cycloolefin-based adhesive layer, and is peeled off by a mechanical force applied at room temperature (for example, Patent Document 3).

### PRIOR ART DOCUMENTS

### Patent Documents

Patent Document 1: Japanese Patent Laid-open Publication No. 2010-254808 (CLAIMS)

Patent Document 2: Japanese Patent Laid-open Publication No. 2013-48215 (CLAIMS)

Patent Document 3: Japanese Patent Laid-open Publication No. 2013-241568 (CLAIMS)

### SUMMARY OF THE INVENTION

### Problems to be Solved by the Invention

However, the adhesive for temporary bonding as in Patent Document 1, which can only be peeled off by heating, has problems that the solder bump is dissolved during the heating step for peeling, that an adhesive force during the semiconductor processing step is reduced and the adhesive is peeled off during the step, or conversely an adhesive force is increased and the adhesive cannot be peeled off.

The adhesive for temporary bonding as in Patent Document 2, which is peeled off by a mechanical force applied at room temperature, is free from the above-mentioned problems. However, two types of adhesive layers have to be formed, which imposes a considerable burden on the process. The adhesive for temporary bonding as in Patent Document 3 is an adhesive which produces one type of adhesive layer, and which is peeled off by a mechanical force applied at room temperature. The cycloolefin-based material, however, has a problem that the material is decomposed in the semiconductor step at high temperatures. Further, in the case of applying the adhesive for temporary bonding, the wafer edge portion is sometimes ridged to cause defects at the time of bonding the wafers together.

In view of such a situation, an object of the present invention to provide a laminate film having an adhesive layer for temporary bonding, which is capable of making a semiconductor circuit formation substrate and a support substrate adhere to each other with one type of adhesive, produces no ridge in the wafer edge portion, is excellent in heat resistance, does not undergo a change in the adhesive force in the course of the production process of a semiconductor device or the like, and can then be peeled off by a mechanical force applied at room temperature under mild conditions or by being dissolved in a rework solvent or the like.

### Solutions to the Problems

That is, the present invention provides a laminate film for temporary bonding, including at least three layers of (A) a protective film layer, (B) an adhesive layer, and (C) a support film layer, wherein the adhesive layer (B) contains at least a siloxane polymer represented by the general formula (1) or a compound represented by the general formula (2):

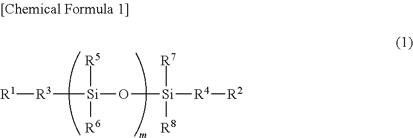

wherein m is an integer of 10 or more and 100 or less, R¹ and R² may be the same or different and each represent a monovalent organic group, R³ and R⁴ may be the same or different and each represent an alkylene group having 1 to 30 carbon atoms or a phenylene group, and R⁵ to R⁸ may be the same or different and each represent an alkyl group having 1 to 30 carbon atoms, an alkenyl group, an alkoxy group, a phenyl group, or a phenoxy group; or

[Chemical Formula 2]

(R⁹ₐ—Si—OR¹⁰)₄₋ₐ (2)

wherein R⁹ represents a monovalent organic group having 2 to 20 carbon atoms and 1 to 3 nitrogen atoms, R¹⁰ represents hydrogen, an alkyl group having 1 to 20 carbon atoms, or an aromatic group, and a represents an integer of 1 to 4.

### Effects of the Invention

The present invention can provide a laminate film for temporary bonding which is excellent in heat resistance, capable of providing a flat film even at the wafer edge portion, and capable of making a semiconductor circuit formation substrate and a support substrate or a support film layer adhere to each other with one type of adhesive, and which can be peeled off at room temperature under mild conditions.

### EMBODIMENTS OF THE INVENTION

The laminate film for temporary bonding of the present invention includes at least three layers of (A) a protective film layer, (B) an adhesive layer, and (C) a support film layer, and the adhesive layer (B) contains at least a siloxane polymer represented by the general formula (1) or a compound represented by the general formula (2).

In one aspect of the laminate film for temporary bonding of the present invention, the adhesive layer (B) contains a siloxane polymer represented by the general formula (1):

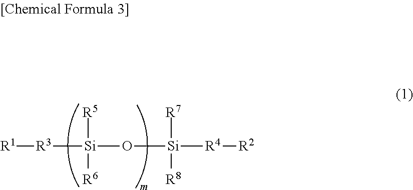

wherein m is an integer of 10 or more and 100 or less, R¹ and R² may be the same or different and each represent a monovalent organic group, R³ and R⁴ may be the same or different and each represent an alkylene group having 1 to 30 carbon atoms or a phenylene group, and R⁵ to R⁸ may be the same or different and each represent an alkyl group having 1 to 30 carbon atoms, an alkenyl group, an alkoxy group, a phenyl group, or a phenoxy group.

R¹ and R² may be the same or different and each represent a monovalent organic group. For example, structures having an alkyl group, an alkenyl group, an alkoxy group, a phenyl group, a phenoxy group, an amino group, a carboxyl group, a hydroxyl group, an epoxy group, an oxetane group, an ether group, an aralkyl group, an amide group, an imide group, a nitro group, or an ester group can be used.

In the general formula (1), m is an integer of 10 or more and 100 or less. When the adhesive layer (B) contains a siloxane polymer in which m is 10 or more and 100 or less, the adhesiveness of the surface of the adhesive layer obtained by applying the adhesive to a wafer and drying the adhesive can be lowered. Therefore, it is possible to make the semiconductor circuit formation substrate and the support substrate adhere to each other, and then peel off the laminate film for temporary bonding by a mechanical force applied at room temperature under mild conditions.

Further, when the adhesive layer (B) contains a siloxane polymer in which m is 10 or more and 100 or less, it is possible to improve the heat resistance of the surface of the adhesive layer, and suppress generation of voids in the adhesive layer during the element processing step after the semiconductor circuit formation substrate and the support substrate are bonded to each other.

The value of m in the polysiloxane polymer can be determined by calculation of the molecular weight through titration or calculation through structure identification. When the polysiloxane polymer has a functional group as a diamine compound does, the value of m can be calculated by titration of the functional group.

The structures of R¹ to R⁸ can be identified by various NMR measurements such as HMBC and HMQC, IR measurement, and the like.

Moreover, a relationship between the value of m and the molecular weight of the polysiloxane polymer can be obtained as a relational expression of a linear function by calculating the molecular weights of the polysiloxane polymer in the cases where m=1 and m=10 from the chemical structural formula. The average value of m can be determined by applying the average of the molecular weights to the relational expression. When the value of m is calculated by structure identification, the value of m can be calculated by structural analysis through various NMR measurements such as HMBC and HMQC, and IR measurement, or the comparison of the number of protons.

From the viewpoint of heat resistance, R¹ and R² are preferably each a structure having an aromatic ring or an aromatic heterocyclic structure. When R¹ and R² are each a structure having an aromatic ring or an aromatic heterocyclic structure, it is possible to further suppress generation of voids in the adhesive layer during the element processing step after the semiconductor circuit formation substrate and the support substrate are bonded to each other. Specific examples of R¹ and R² include the following structures, but are not limited thereto.

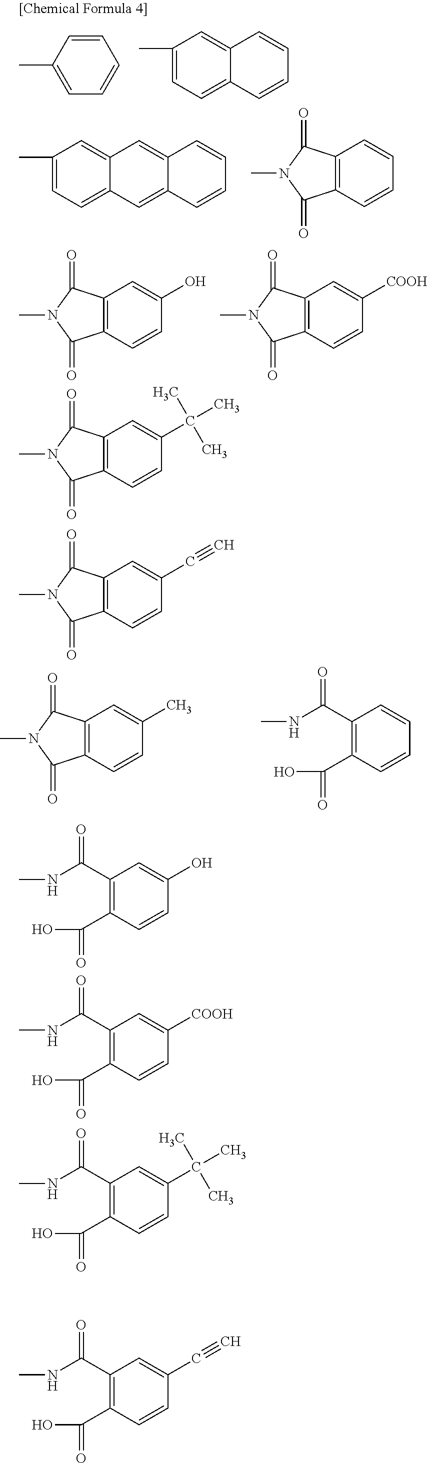

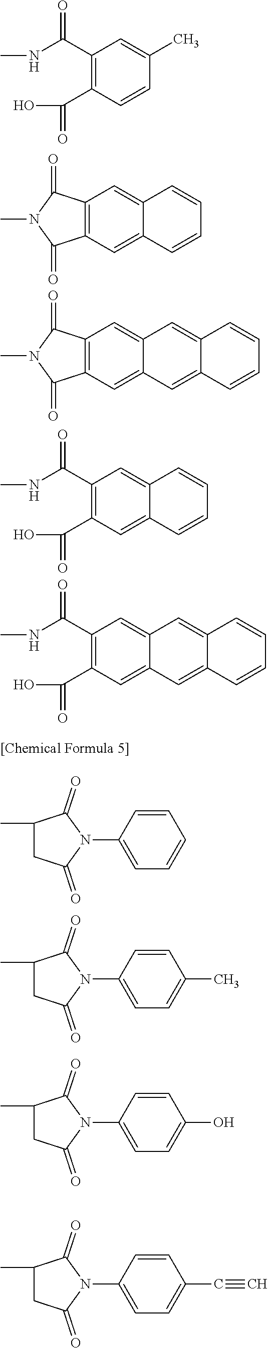

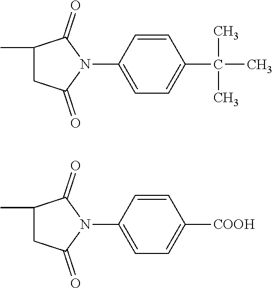

The content of the siloxane polymer represented by the general formula (1) is preferably 0.01% by mass or more and 30% by mass or less, more preferably 0.1% by mass or more and 15% by mass or less in components contained in the adhesive layer (B). When the content is 0.01% by mass or more, the peeling property is further improved. When the content is 30% by mass or less, the adhesiveness between the adhesive layer and the semiconductor circuit formation substrate or the support substrate can be further maintained.

In another aspect of the laminate film for temporary bonding of the present invention, the adhesive layer (B) contains a compound represented by the general formula (2):

[Chemical Formula 6]

(R⁹)ₐ—Si—OR¹⁰)₄₋ₐ (2)

wherein R⁹ represents a monovalent organic group having 2 to 20 carbon atoms and 1 to 3 nitrogen atoms, R¹⁰ represents hydrogen, an alkyl group having 1 to 20 carbon atoms, or an aromatic group, and a represents an integer of 1 to 4.

When the adhesive layer (B) contains a compound represented by the general formula (2), the adhesiveness between the adhesive layer and the semiconductor circuit formation substrate or the support substrate can be improved, and therefore generation of voids at the interface with the adhesive layer can be suppressed during the heating step after the semiconductor circuit formation substrate and the support substrate are bonded to each other. Further, it is presumed that incorporation of nitrogen atoms into the adhesive layer enhances the interaction between molecules and increases the adhesive force of the adhesive layer.

R⁹ represents a monovalent organic group having 2 to 20 carbon atoms and 1 to 3 nitrogen atoms. For example, a structure having an amino group, an isocyanate group, a ureido group, or an amide group can be used. Specific examples of the compound represented by the general formula (2) include the following structures, but are not limited thereto.

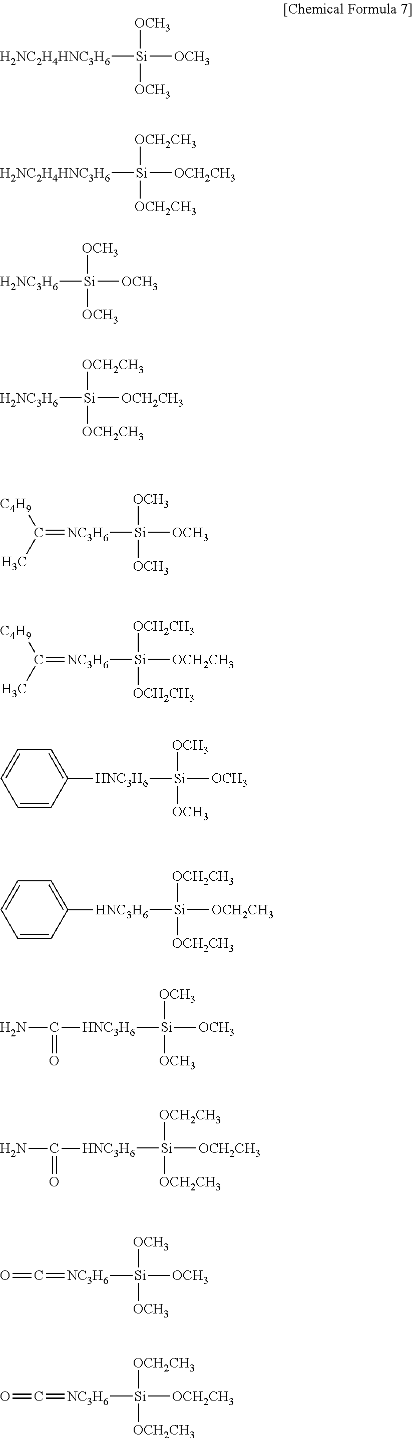

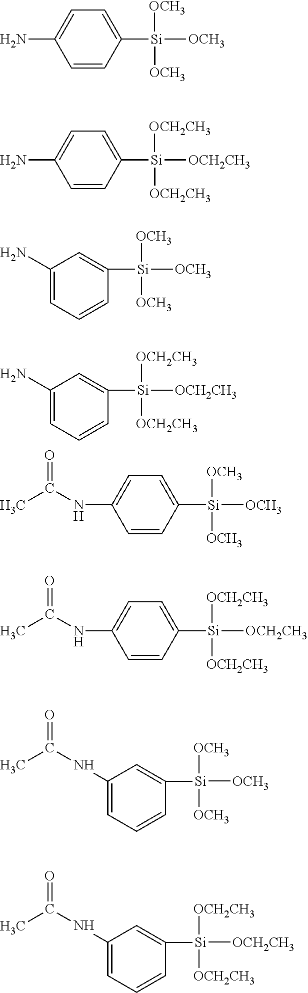

Further, from the viewpoint of heat resistance, R⁹ is preferably a structure having an aromatic ring or an aromatic heterocyclic structure. Preferable specific examples of the compound represented by the general formula (2) include the following structures, but are not limited thereto.

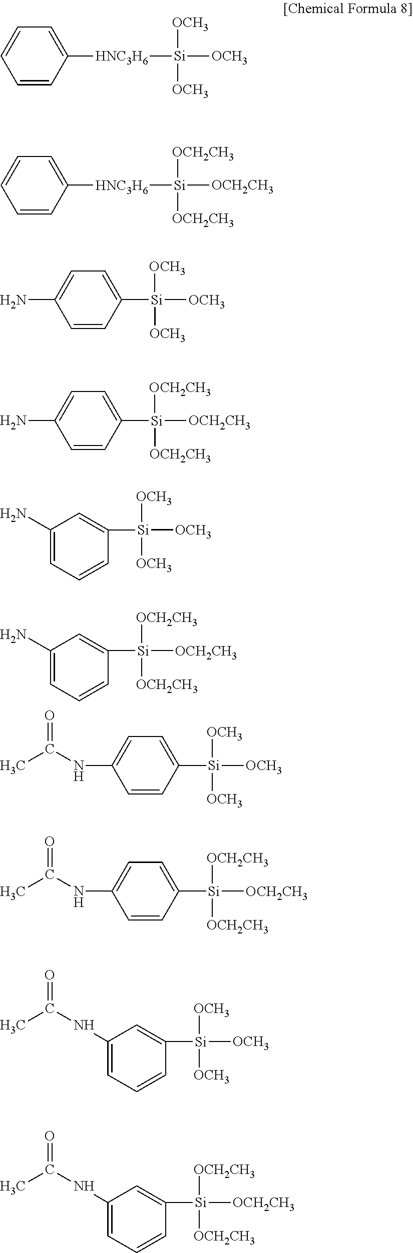

The content of the compound represented by the general formula (2) is preferably 0.01% by mass or more and 30% by mass or less, more preferably 0.1% by mass or more and 15% by mass or less in components contained in the adhesive layer (B). When the content of the compound is 0.1% by mass, an effect of suppressing generation of voids is exerted. When the content is 15% by mass or less, an increase in flowability of the adhesive layer is suppressed, and as a result, generation of voids in the adhesive layer during the heating step can be suppressed.

The adhesive layer (B) included in the laminate film for temporary bonding of the present invention preferably further contains a resin (b) other than the siloxane polymer represented by the general formula (1). The type of the resin (b) is not particularly limited, and any resin may be used as long as it can be generally used in electronic material applications. Examples of the resin (b) include, but are not limited to, polymer resins such as polyimide resins, acrylic resins, acrylonitrile resins, butadiene resins, urethane resins, polyester resins, polyamide resins, polyamide-imide resins, epoxy resins, phenolic resins, silicone resins, and alicyclic resins. These resins may be used singly, or two or more of them may be used in combination. From the viewpoint of film formability, the content of the resin (b) is preferably 50% by mass or more, more preferably 60% by mass or more in components contained in the adhesive layer (B). In addition, from the viewpoint of the peeling property, the content of the resin (b) is preferably 99.99% by mass or less, more preferably 99.9% by mass or less in components contained in the adhesive layer (B).

The glass transition temperature of the resin (b) is preferably 100° C. or lower. When the glass transition temperature is 100° C. or lower, the adhesive layer can exhibit higher tackiness when a substrate serving as an adherend is thermocompression-bonded to the adhesive layer of the laminate film for temporary bonding of the present invention.

Further, the 1% weight loss temperature of the resin (b) is preferably 300° C. or higher, more preferably 350° C. or higher. When the 1% weight loss temperature is 300° C. or higher, voids are not generated in the adhesive layer during the element processing step, and the adhesive layer can exhibit high heat resistance.

The 1% weight loss temperature can be measured with use of a thermogravimetric analyzer (TGA). As for the measurement method, a predetermined amount of a resin is charged in the TGA, and held at 60° C. for 30 minutes for removal of the moisture absorbed in the resin. Then, the resin is heated to 500° C. at a rate of 5° C./min. The temperature at which 1% of the weight has been lost in the obtained weight loss curve is evaluated to measure the 1% weight loss temperature.

The resin (b) is preferably a polyimide resin. That is, the adhesive layer (B) included in the laminate film for temporary bonding of the present invention preferably contains a polyimide resin. When the adhesive layer (B) contains a polyimide resin, a 1% weight loss temperature of 300° C. or higher can be easily achieved. When the resin (b) is a polyimide resin, from the viewpoint of heat resistance, the content of the resin (b) is preferably 30% by mass or more, more preferably 50% by mass or more, still more preferably 60% by mass or more, even more preferably 70% by mass or more, even more preferably 80% by mass or more in components contained in the adhesive layer (B). When the resin (b) is a mixture of a polyimide resin and other resins, the content of the polyimide resin is preferably 60% by mass or more, more preferably 70% by mass or more, still more preferably 80% by mass or more, even more preferably 90% by mass or more in components contained in the resin (b).

The polyimide resin has at least an acid dianhydride residue and a diamine residue, and preferably contains a residue of a polysiloxane diamine represented by the general formula (3):

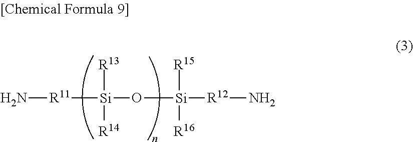

wherein n is a natural number, and has an average value calculated from the average molecular weight of the polysiloxane diamine of 1 or more and 100 or less, R¹¹ and R¹² may be the same or different and each represent an alkylene group having 1 to 30 carbon atoms or a phenylene group, and R¹³ to R¹⁶ may be the same or different and each represent an alkyl group having 1 to 30 carbon atoms, a phenyl group, or a phenoxy group.

The average molecular weight of the polysiloxane diamine can be determined by calculating the amino group equivalent through neutralization titration of amino groups of the polysiloxane diamine, and doubling the amino group equivalent. For example, a predetermined amount of a polysiloxane diamine serving as a sample is taken and put in a beaker, and dissolved in a predetermined amount of a 1:1 mixed solution of isopropyl alcohol (hereinafter referred to as IPA) and toluene. To the resulting solution, a 0.1 N aqueous hydrochloric acid solution is added dropwise with stirring, the amount of the 0.1 N aqueous hydrochloric acid solution added until the neutralization point is determined, and the amino group equivalent is calculated from the amount of the added aqueous solution. A value obtained by doubling the amino group equivalent is the average molecular weight.

The structures of R¹³ to R¹⁶ can be identified by various NMR measurements such as HMBC and HMQC, IR measurement, and the like.

Meanwhile, a relationship between the value of n and the molecular weight of the polysiloxane diamine can be obtained as a relational expression of a linear function by calculating the molecular weights of the polysiloxane diamine in the cases where n=1 and n=10 from the chemical structural formula. The average value of n can be determined by applying the average of the molecular weights to the relational expression.

Further, since the polysiloxane diamine represented by the general formula (3) is sometimes a mixture in which n is not a single value but has a plurality of values, n represents an average value in the present invention.

Specific examples of the polysiloxane diamine represented by the general formula (3) include α,ω-bis(3-aminopropyl)polydimethylsiloxane, α,ω-bis(3-aminopropyl)polydiethylsiloxane, α,ω-bis(3-aminopropyl)polydipropylsiloxane, α,ω-bis(3-aminopropyl)polydibutylsiloxane, α,ω-bis(3-aminopropyl)polydiphenoxysiloxane, α,ω-bis(2-aminoethyl)polydimethylsiloxane, α,ω-bis(2-aminoethyl)polydiphenoxysiloxane, α,ω-bis(4-aminobutyl)polydimethylsiloxane, α,ω-bis(4-aminobutyl)polydiphenoxysiloxane, α,ω-bis(5-aminopentyl)polydimethylsiloxane, α,ω-bis(5-aminopentyl)polydiphenoxysiloxane, α,ω-bis(4-aminophenyl)polydimethylsiloxane, and α,ω-bis(4-aminophenyl)polydiphenoxysiloxane. These polysiloxane diamines may be used singly, or two or more of them may be used. Use of siloxane diamines different in n in combination is preferable because adhesive force can be controlled.

Among these polysiloxane diamines, polysiloxane diamines in which n is 2 or more are preferable, and such diamines can lower the glass transition temperature of the resin (b). The glass transition temperature of the resin (b) is preferably 100° C. or lower. In this case, the adhesive layer can exhibit high adhesiveness at the time of thermocompression bonding. In addition, from the viewpoint of adhesiveness, n of the polysiloxane diamine represented by the general formula (3) is preferably 1 or more and 20 or less. Use of a polysiloxane diamine in which n is 1 or more and 20 or less increases the adhesive force to a substrate such as a semiconductor circuit formation substrate and a support substrate, and enables processing of the substrate without peeling in a step of thinning the substrate, for example.

The content of the residue of the polysiloxane diamine represented by the general formula (3) is preferably 30 mol % or more, more preferably 40 mol % or more, still more preferably 60 mol % or more in all the diamine residues. A content within this range makes it possible to greatly lower the glass transition temperature of the resin, and enables bonding at low temperatures. In addition, from the viewpoint of adhesiveness, the content of the residue of the polysiloxane diamine represented by the general formula (3) is preferably 95 mol % or less, more preferably 90 mol % or less, still more preferably 85 mol % or less in all the diamine residues. A content within this range makes it possible to increase the adhesive force to a substrate such as a semiconductor circuit formation substrate and a support substrate, and enables processing of the substrate without peeling in a step of thinning the substrate, for example.

The polyimide resin may have a residue of an aromatic diamine or a residue of an alicyclic diamine. From the viewpoint of adhesiveness and the peeling property, the content of the residue of an aromatic diamine or the residue of an alicyclic diamine is preferably 0.1 mol % or more and 70 mol % or less, more preferably 0.1 mol % or more and 60 mol % or less in all the diamine residues.

Specific examples of the aromatic diamine or the alicyclic diamine include 2,5-diaminophenol, 3,5-diaminophenol, 3,3′-dihydroxybenzidine, 4,4′-dihydroxy-3,3′-diaminophenyl propane, 4,4′-dihydroxy-3,3′-diaminophenyl hexafluoropropane, 4,4′-dihydroxy-3,3′-diaminophenyl sulfone, 4,4′-dihydroxy-3,3′-diaminophenyl ether, 3,3′-dihydroxy-4,4′-diaminophenyl ether, 4,4′-dihydroxy-3,3′-diaminophenyl propane methane, 4,4′-dihydroxy-3,3′-diaminobenzophenone, 1,3-bis(4-amino-3-hydroxy phenyl) benzene, 1,3-bis(3-amino-4-hydroxy phenyl) benzene, bis(4-(4-amino-3-hydroxy phenoxy)benzene)propane, bis(4-(3-amino-4-hydroxy phenoxy)benzene)sulfone, bis(4-(3-amino-4-hydroxy phenoxy))biphenyl, p-phenylene diamine, m-phenylene diamine, 2,5-diaminotoluene, 2,4-diaminotoluene, 3,5-diaminobenzoic acid, 2,6-diaminobenzoic acid, 2-methoxy-1,4-phenylene diamine, 4,4′-diaminobenzanilide, 3,4′-diaminobenzanilide, 3,3′-diaminobenzanilide, 3,3′-dimethyl-4,4′-diaminobenzanilide, 9,9-bis(4-aminophenyl)fluorene, 9,9-bis(3-aminophenyl)fluorene, 9,9-bis(3-methyl-4-aminophenyl)fluorene, 9,9-bis(3,5-dimethyl-4-aminophenyl)fluorene, 9,9-bis(3-methoxy-4-aminophenyl)fluorene, 9,9-bis(4-aminophenyl)fluorene-4-carboxylic acid, 9,9-bis(4-aminophenyl)fluorene-4-methyl, 9,9-bis(4-aminophenyl)fluorene-4-methoxy, 9,9-bis(4-aminophenyl)fluorene-4-ethyl, 9,9-bis(4-aminophenyl)fluorene-4-sulfone, 9,9-bis(4-aminophenyl)fluorene-3-carboxylic acid, 9,9-bis(4-aminophenyl)fluorene-3-methyl, 1,3-diaminocyclohexane, 2,2′-dimethyl benzidine, 3,3′-dimethyl benzidine, 3,3′-dimethoxy benzidine, 2,4-diaminopyridine, 2,6-diaminopyridine, 1,5-diaminonaphthalene, 2,7-diaminofluorene, p-amino benzylamine, m-amino benzylamine, 4,4′-bis(4-aminophenoxy)biphenyl, 4,4′-diaminodiphenyl ether, 3,3′-diaminodiphenyl ether, 3,4′-diaminodiphenyl ether, 4,4′-diaminodiphenyl sulfone, 3,3′-diaminodiphenyl sulfone, 3,3′-diaminodiphenyl methane, 4,4′-diaminodiphenyl methane, 4,4′-diaminodiphenyl sulfide, 3,3′-diamino benzophenone, 3,4′-diamino benzophenone, 4,4′-diamino benzophenone, 3,3′-dimethyl-4,4′-diaminodiphenyl methane, 1,3-bis(4-aminophenoxy)benzene, 1,3-bis(3-aminophenoxy)benzene, 1,4-bis(4-aminophenoxy)benzene, 1,4-bis(3-aminophenoxy)benzene, 2,2-bis[4-(4-aminophenoxy)phenyl]propane, 2,2-bis[4-(3-aminophenoxy)phenyl]propane, bis[4-(4-aminophenoxy)phenyl]methane, bis[4-(3-aminophenoxy)phenyl]methane, bis[4-(4-aminophenoxy)phenyl]ether, bis[4-(3-aminophenoxy)phenyl]ether, bis[4-(4-aminophenoxy)phenyl]sulfone, bis[4-(3-aminophenoxy)phenyl]sulfone, 2,2-bis[4-(4-aminophenoxy)phenyl]hexafluoropropane, 1,4-diamino cyclohexane, 4,4′-methylene bis (cyclohexyl amine), 3,3′-methylene bis(cyclohexyl amine), 4,4′-diamino-3,3′-dimethyl dicyclohexyl methane, 4,4′-diamino-3,3′-dimethyl dicyclohexyl, and benzidine. These aromatic diamines or alicyclic diamines may be used singly, or two or more of them may be used.

Among these aromatic diamines and alicyclic diamines, aromatic diamines having a structure with high bendability are preferable. Specifically, 1,3-bis(3-aminophenoxy)benzene, 3,3′-diaminodiphenyl sulfone, 4,4′-diaminodiphenyl ether, 3,3′ -diaminodiphenyl ether, and 3,3′ -diamino benzophenone are particularly preferable.

The polyimide resin preferably contains a residue of an aromatic tetracarboxylic dianhydride as the acid dianhydride residue. When the polyimide resin contains a residue of an aromatic tetracarboxylic dianhydride, the 1% weight loss temperature is 300° C. or higher. Therefore, voids are not generated in the adhesive layer during the heating step, and the adhesive layer can exhibit high heat resistance.

Specific examples of the aromatic tetracarboxylic dianhydride include pyromellitic dianhydride, 3,3′,4,4′-biphenyltetracarboxylic dianhydride, 2,2′-dimethyl-3,3′,4,4′-biphenyltetracarboxylic dianhydride, 5,5′-dimethyl-3,3′,4,4′-biphenyltetracarboxylic dianhydride, 2,3,3′,4′-biphenyltetracarboxylic dianhydride, 2,2′,3,3′-biphenyltetracarboxylic dianhydride, 3,3′,4,4′-diphenyl ether tetracarboxylic dianhydride, 2,3,3′,4′-diphenyl ether tetracarboxylic dianhydride, 2,2′,3,3′-diphenyl ether tetracarboxylic dianhydride, 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,3,3′,4′-diphenylsulfone tetracarboxylic dianhydride, 3,3′,4,4′-diphenylsulfoxide tetracarboxylic dianhydride, 3,3′,4,4′-diphenylsulfide tetracarboxylic dianhydride, 3,3′,4,4′-diphenylmethylene tetracarboxylic dianhydride, 4,4′-isopropylidenediphthalic anhydride, 4,4′-(hexafluoroisopropylidene)diphthalic anhydride, 3,4,9,10-perylenetetracarboxylic dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 3,3″,4,4″-p-terphenyltetracarboxylic dianhydride, 3,3″,4,4″-m-terphenyltetracarboxylic dianhydride, 2,3,6,7-anthracenetetracarboxylic dianhydride, and 1,2,7,8-phenanethrenetetracarboxylic dianhydride. These aromatic tetracarboxylic dianhydrides may be used singly, or two or more of them may be used.

Further, the polyimide resin may contain a tetracarboxylic dianhydride having an aliphatic ring to such an extent that the heat resistance of the polyimide resin is not impaired. Specific examples of the tetracarboxylic dianhydride having an aliphatic ring include 2,3,5-tricarboxycyclopentyl acetic dianhydride, 1,2,3,4-cyclobutanetetracarboxylic dianhydride, 1,2,3,4-cyclopentanetetracarboxylic dianhydride, 1,2,3,5-cyclopentanetetracarboxylic dianhydride, 1,2,4,5-bicyclohexenetetracarboxylic dianhydride, 1,2,4,5-cyclohexanetetracarboxylic dianhydride, and 1,3,3a,4,5,9b-hexahydro-5-(tetrahydro-2,5-dioxo-3-furanyl)-naphtho[1,2-C]furane-1,3-dione. These tetracarboxylic dianhydrides may be used singly, or two or more of them may be used.

The molecular weight of the polyimide resin can be adjusted by using equimolar amounts of a tetracarboxylic acid component and a diamine component for the synthesis, or by using either of these components in excess. It is also possible to use either of the tetracarboxylic acid component and the diamine component in excess and block the terminal of the polymer chain with a terminal blocking agent such as an acid component or an amine component. As the terminal blocking agent of the acid component, a dicarboxylic acid or an anhydride thereof is preferably used. As the terminal blocking agent of the amine component, a monoamine is preferably used. In the adjustment, it is preferable to adjust the acid equivalent of the tetracarboxylic acid component and the amine equivalent of the diamine component to be equimolar including those of the terminal blocking agent of the acid component or the amine component.

When the molar ratio is adjusted so that the tetracarboxylic acid component is in excess or the diamine component is in excess, dicarboxylic acids such as benzoic acid, phthalic anhydride, tetrachlorophthalic anhydride, and aniline, or anhydrides thereof, or monoamines may be added as a terminal blocking agent.

The molar ratio of the tetracarboxylic acid component to the diamine component in the polyimide resin can be appropriately adjusted so that the viscosity of the resin composition falls within a range in which the resin composition is easy to use in coating or the like. The molar ratio of the tetracarboxylic acid component to the diamine component is generally adjusted in the range of 100/100 to 100/95 or 100/100 to 95/100. If the molar balance is disrupted, the molecular weight of the resin decreases, mechanical strength of the film formed from the resin decreases, and the adhesive force of the film tends to be low. Therefore, it is preferable to adjust the molar ratio in the range in which the adhesive force is not reduced.

The method of obtaining the polyimide resin by polymerization is not particularly limited. For example, when polyamic acid as a polyimide precursor is obtained by polymerization, a tetracarboxylic dianhydride and a diamine in an organic solvent are stirred at 0 to 100° C. for 1 to 100 hours to give a polyamic acid resin solution. When the polyimide resin is soluble in the organic solvent, after the polyamic acid is obtained by polymerization, the temperature is raised to 120 to 300° C., and the polyamic acid resin solution is stirred as it is for 1 to 100 hours to convert the polyamic acid into a polyimide. In this way, a polyimide resin solution is obtained. In this process, toluene, o-xylene, m-xylene, or p-xylene may be added to the reaction solution to remove water produced in the imidization reaction by azeotropy of the solvent and water.

The polyimide resin may be either of a ring-closed polyimide resin or polyamic acid which is a precursor of the polyimide. The polyimide resin may be a partially ring-closed and imidized polyimide precursor. When a polyimide precursor is used, the substrate may be warped due to curing shrinkage caused by dehydration in the heat treatment, or voids may be generated by the removed water. Thus, the polyimide resin is preferably a ring-closed polyimide resin.

Examples of the solvent for the synthesis of a polyimide resin or polyamic acid as a polyimide precursor include, but are not limited to, amide-based polar solvents such as N-methyl-2-pyrrolidone, N,N-dimethylacetamide, and N,N-dimethylformamide, lactone-based polar solvents such as β-propiolactone, γ-butyrolactone, γ-valerolactone, δ-valerolactone, γ-caprolactone, and ε-caprolactone, and methyl cellosolve, methyl cellosolve acetate, ethyl cellosolve, ethyl cellosolve acetate, methyl carbitol, ethyl carbitol, ethyl lactate, propylene glycol mono-t-butyl ether, ethylene glycol mono-t-butyl ether, propylene glycol mono-n-butyl ether, propylene glycol monopropyl ether, propylene glycol monoethyl ether, ethylene glycol mono-n-butyl ether, ethylene glycol monopropyl ether, dipropylene glycol dimethyl ether, dipropylene glycol diethyl ether, dipropylene glycol dipropyl ether, dipropylene glycol di-n-butyl ether, dipropylene glycol di-t-butyl ether, dipropylene glycol monomethyl ether, dipropylene glycol monoethyl ether, dipropylene glycol monopropyl ether, dipropylene glycol mono-n-butyl ether, tripropylene glycol monomethyl ether, tripropylene glycol monoethyl ether, tripropylene glycol monopropyl ether, diethylene glycol methyl ethyl ether, diethylene glycol dimethyl ether, and triethylene glycol dimethyl ether. These solvents may be used singly, or two or more of them may be used.

Usually, the concentration of the polyimide resin solution or the polyamic acid resin solution is preferably 10% by mass or more and 80% by mass or less, more preferably 20% by mass or more and 70% by mass or less.

In the case of the polyamic acid resin solution, the polyamic acid resin solution may be converted into a polyimide resin by heat treatment after being applied to the support film layer (C) and dried for formation of a coating film. Conversion of a polyimide precursor into a polyimide requires a temperature of 240° C. or higher. However, when a polyamic acid resin composition contains an imidization catalyst, imidization at a lower temperature and in a shorter time is made possible. Specific examples of the imidization catalyst include, but are not limited to, pyridine, trimethylpyridine, β-picoline, quinoline, isoquinoline, imidazole, 2-methylimidazole, 1,2-dimethylimidazole, 2-phenylimidazole, 2,6-lutidine, triethylamine, m-hydroxybenzoic acid, 2,4-dihydroxybenzoic acid, p-hydroxyphenylacetic acid, 4-hydroxyphenylpropionic acid, p-phenolsulfonic acid, p-aminophenol, and p-aminobenzoic acid.

The content of the imidization catalyst is preferably 3 parts by weight or more, more preferably 5 parts by weight or more based on 100 parts by weight of the solid content of polyamic acid. When the polyamic acid resin composition contains 3 parts by weight or more of the imidization catalyst, imidization can be completed even by heat treatment at a lower temperature. The content of the imidization catalyst is preferably 10 parts by weight or less, more preferably 8 parts by weight or less. Setting the content of the imidization catalyst to 10 parts by weight or less makes it possible to minimize the amount of the imidization catalyst which remains in a polyimide resin layer after the heat treatment to suppress generation of volatile matters.

The adhesive layer (B) included in the laminate film for temporary bonding of the present invention preferably contains inorganic fine particles from the viewpoint of heat resistance and the peeling property. As the material of the inorganic fine particles, silica, alumina, titania, silicon nitride, boron nitride, aluminum nitride, iron oxide, glass, other metal oxides, metal nitrides, and metal carbonates, and metal sulfates such as barium sulfate may be used singly, or two or more of them may be used in combination.

The shape of the inorganic fine particles may be any of a spherical shape, and nonspherical shapes such as a crushed shape and a flake shape. Spherical inorganic fine particles can be preferably used because they are easily dispersed uniformly in the adhesive composition. The average particle diameter of the spherical inorganic fine particles is preferably 20 μm or less, more preferably 10 μm or less, still more preferably 5 μm or less from the viewpoint of embeddability of the adhesive layer in an uneven substrate. The average particle diameter of the inorganic fine particles is preferably 5 nm or more, more preferably 10 nm or more. When the average particle diameter is 5 nm or more, the inorganic fine particles are more excellent in dispersibility, and it is possible to fill the adhesive layer with the inorganic fine particles at a high density.

The average particle diameter of the inorganic fine particles refers to the particle diameter of one inorganic fine particle present alone, and refers to the particle diameter of most frequent particles. When the particles have a spherical shape, the average particle diameter represents the diameter of the spherical particles. When the particles have an elliptical or flat shape, the average particle diameter represents the maximum length of the shape. Further, when the particles have a rod-like or fibrous shape, the average particle diameter represents the maximum length of the shape in the longitudinal direction. The average particle diameter of the inorganic fine particles in the adhesive layer can be measured by a method of observing the particles directly with a SEM (scanning electron microscope), and calculating the average of the particle diameters of 100 particles.

The content of the inorganic fine particles is preferably 60% by mass or less, more preferably 40% by mass, still more preferably 20% by mass based on the total amount of the adhesive layer components from the viewpoint of adhesiveness. The content of the inorganic fine particles is preferably 1% by mass or more, more preferably 3% by mass or more based on the total amount of the adhesive layer components from the viewpoint of suppressing voids during heating.

The laminate film for temporary bonding of the present invention having three layers of the protective film layer (A), the adhesive layer (B), and the support film layer (C) can be produced by forming the adhesive layer (B) on the support film layer (C), and then laminating the protective film layer (A) on the surface of the adhesive layer (B). That is, the laminate film for temporary bonding of the present invention is formed by laminating the support film layer (C), the adhesive layer (B), and the protective film layer (A) in this order. The adhesive layer (B) in the present invention means a resin layer containing at least the siloxane polymer represented by the general formula (1) or the compound represented by the general formula (2). The adhesive layer (B) contains at least the siloxane polymer represented by the general formula (1) or the compound represented by the general formula (2), and may contain both of them.

The method of forming the adhesive layer (B) on the support film layer (C) may be a method of applying an adhesive coating material to the support film layer (C), and volatilizing the solvent. The adhesive coating material as used herein means a composition containing components that form the adhesive layer dissolved in an organic solvent, and may contain additives such as a surfactant and an adhesion aid.

The adhesive coating material may be prepared by a method of mixing at least the siloxane polymer represented by the general formula (1) or the compound represented by the general formula (2) with an organic solvent, additives, and the like. Alternatively, the adhesive coating material may be prepared by adding at least the siloxane polymer represented by the general formula (1) or the compound represented by the general formula (2), or adding a solvent, additives, and the like to a resin solution prepared by polymerization. Further, the adhesive coating material may be prepared by mixing a resin produced by purification treatment such as reprecipitation or a commercially available resin, at least the siloxane polymer represented by the general formula (1) or the compound represented by the general formula (2), an organic solvent, additives, and the like.

Examples of the method of applying the adhesive coating material include methods such as spray coating, roll coating, screen printing, blade coating, die coating, calender coating, meniscus coating, bar coating, roll coating, comma roll coating, gravure coating, screen coating, and slit die coating, and any of these methods may be used. After the coating, the solvent in the adhesive coating material is removed by heat treatment to dry the adhesive coating material. In this way, an adhesive layer is formed on the support film layer. The heat treatment temperature is 80° C. or higher and 300° C. or lower, preferably 100° C. or higher and 250° C. or lower. Usually, the heat treatment time is appropriately selected in the range of 20 seconds to 30 minutes, and the heat treatment may be performed continuously or intermittently.

The thickness of the adhesive layer to be laminated can be appropriately selected, and is 0.1 μm or more and 500 μm or less. The thickness is preferably 1 μm or more, more preferably 2 μm or more. The thickness is preferably 100 μm or less, more preferably 70 μm or less. The thickness of the adhesive layer is preferably 10 μm or more from the viewpoints of the property of being laminated on an uneven substrate, such as a substrate with a copper pillar bump, and embeddability in an uneven portion.

The support film layer (C) used in the laminate film for temporary bonding of the present invention is not particularly limited. Examples of the support film layer (C) include the following plastic films: a polypropylene film, a polyethylene film, a polystyrene film, a polyethylene terephthalate (PET) film, a polyphenylene sulfide (PPS) film, a polyimide film, a polyamide film, a polyamideimide film, a polyester film, an aromatic polyester film, a polyethersulfone film, fluorine-containing polymer films such as a polytetrafluoroethylene film (PTFE), a polyether ether ketone film, a polystyrene film, a polyphenylene ether film, a polyarylate film, and a polysulfone film. Specific examples of the plastic film include, but are not limited to, “Lumirror” (registered trademark), “Torelina” (registered trademark), and “Torayfan” (registered trademark) (manufactured by Toray Industries, Inc.), “Kapton” (registered trademark) (manufactured by DU PONT-TORAY CO., LTD.), “Upilex” (registered trademark) (manufactured by Ube Industries, Ltd.), and “Apical” (registered trademark) (manufactured by KANEKA CORPORATION) (all trade names).

When the support film layer (C) is subjected to a heating step at 150° C. to 450° C., such as reflow treatment, a plasma CVD step, a plasma PVD step, or a sintering step, a support film layer (C) having a high melting point is preferably used from the viewpoint of suppressing deformation and voids. Since the melting point of the support film layer (C) needs to be equal to or higher than the temperature of the heating step to which the support film layer (C) is subjected, it is preferable to use a support film layer (C) having a high melting point. That is, the melting point of the support film layer (C) is preferably 150° C. or higher, more preferably 200° C. or higher, still more preferably 220° C. or higher, even more preferably 240° C. or higher, particularly preferably 260° C. or higher.

For the same reason, it is preferable to use a support film layer (C) having a high thermal decomposition temperature. The thermal decomposition temperature as used herein means the 1% weight loss temperature, and can be measured with use of a thermogravimetric analyzer (TGA). As for the measurement method, a predetermined amount of the support film layer (C) is charged in the TGA, and heated to 450° C. at 5° C./min in an air atmosphere. The temperature at which 1% of the weight has been lost in the obtained weight loss curve is evaluated to measure the 1% weight loss temperature. The 1% weight loss temperature of the support film layer (C) is preferably 200° C. or higher, more preferably 260° C. or higher, still more preferably 300° C. or higher.

From these viewpoints, the support film layer (C) is preferably a polyphenylene sulfide (PPS) film or a polyimide film, more preferably a polyimide film.

Further, when the support film layer (C) is subjected to a heating step such as reflow treatment, a plasma CVD step, a plasma PVD step, or a sintering step, the substrate may be warped due to a difference in linear expansion coefficient between the substrate and the support film layer (C). From the viewpoint of prevention of warpage of the substrate, the linear expansion coefficient in the TD and MD of the support film layer (C) is preferably 30 ppm/° C. or less, more preferably 20 ppm/° C. or less, still more preferably 10 ppm/° C. or less. The linear expansion coefficient as used herein can be measured with a linear expansion measuring apparatus (TMA). The linear expansion coefficient can be measured by a method of charging the support film layer (C) in the TMA, heating the support film layer (C) to 200° C. at 10° C./min, and evaluating the linear expansion coefficient in the range of 50° C. to 200° C.

The thickness of the support film layer (C) is not particularly limited. The thickness is preferably 3 μm or more, more preferably 5 μm or more, still more preferably 10 μm or more from the viewpoint of strength as a support. The thickness is preferably 300 μm or less, more preferably 200 μm or less, still more preferably 100 μm or less, even more preferably 80 μm or less from the viewpoint of flexibility.

Further, when the support film layer (C) is subjected to a heating step such as reflow treatment, a plasma CVD step, a plasma PVD step, or a sintering step, the thickness is preferably 30 μm or more, more preferably 50 μm or more, still more preferably 100 μm or more, even more preferably 150 μm or more from the viewpoint of handleability and prevention of warpage of the substrate.

In order to increase the thickness of the support film layer (C), the support film layer (C) may be a laminate of plastic films. Further, it is preferable to use a thick film having a low linear expansion coefficient as the support film layer (C). The support film layer (C) is preferably a laminate of plastic films each having a linear expansion coefficient in the TD and MD of 30 ppm/° C. or less, more preferably a laminate of plastic films each having a linear expansion coefficient of 20 ppm/° C. or less, still more preferably a laminate of plastic films each having a linear expansion coefficient of 10 ppm/° C. or less.

When the laminate film for temporary bonding of the present invention is used as a transfer film for the adhesive layer (B), one surface or both surfaces of the support film layer (C) may be subjected to release treatment according to the purpose. The transfer film as used herein means a film material used for forming only the adhesive layer (B) on the substrate. More specifically, the transfer film as used herein means a laminate film for temporary bonding which is used in the following manner: the protective film layer (A) of the laminate film for temporary bonding is peeled off, a laminate of the adhesive layer (B) and the support film layer (C) is laminated on the substrate by a method such as vacuum thermal lamination so that the adhesive layer comes into contact with the substrate, and then only the support film layer (C) is peeled off. The support film layer (C) is preferably subjected to release treatment by the application of a silicone resin, a fluororesin or the like.

The surface energy of the support film layer (C) is preferably 13 mJ/m² or more from the viewpoint of handling of the laminate film for temporary bonding. When the surface energy of the support film layer (C) is 13 mJ/m² or more, defects hardly occur in the adhesive layer when the protective film layer (A) is peeled off. The surface energy of the support film layer as used herein is the surface energy calculated according to the Owens-Wendt equation. For example, the surface energy can be calculated according to the Owens-Wendt equation in the following manner: droplets of pure water and diiodomethane are formed on the support film layer, then the contact angles of the droplets at the interface with the film are measured with an automatic contact angle meter (DM-500 (manufactured by Kyowa Interface Science Co., Ltd.)) or the like, and the surface energy is calculated using the contact angles.

In use of the laminate film for temporary bonding as a transfer film for the adhesive layer (B), the surface energy of the support film layer is preferably 13 mJ/m² or more, more preferably 14 mJ/m² or more. When the surface energy of the support film layer is 13 mJ/m² or more, it is possible to transfer the adhesive layer without any defects in the adhesive layer. In use of the laminate film for temporary bonding as a transfer film for the adhesive layer (B), the surface energy of the support film layer is preferably 40 mJ/m² or less, more preferably 35 mJ/m² or less, still more preferably 32 mJ/m² or less, even more preferably 30 mJ/m² or less, even more preferably 26 mJ/m² or less, even more preferably 20 mJ/m² or less from the viewpoint of the peeling property of the support film layer. When the surface energy of the support film layer is within this range, in use of the laminate film for temporary bonding as a transfer film for the adhesive layer (B), generation of peeling traces of the support film on the surface of the adhesive layer can be suppressed after the support film layer is peeled off.

In the case of producing a substrate workpiece using the laminate film for temporary bonding and processing the substrate, that is, in the case of using the laminate film for temporary bonding for a substrate workpiece, the surface energy of the support film layer is preferably 40 mJ/m2 or more. When the surface energy of the support film layer is 40 mJ/m² or more, the adhesive layer does not remain on the substrate and moves to the support film layer after the support film layer is peeled off, and removal of the adhesive layer and the washing of the substrate are facilitated. The surface energy of the support film layer is preferably 40 mJ/m² or more, more preferably 50 mJ/m² or more, still more preferably 60 mJ/m² or more from the viewpoint of removability of the adhesive layer at the time the support film layer is peeled off.

The laminate film for temporary bonding of the present invention has the protective film layer (A) for protecting the adhesive layer (B) on the adhesive layer (B). This makes it possible to protect the surface of the adhesive layer from contaminants such as dust and dirt in the atmosphere. As the protective film layer (A), a polyethylene film, a polypropylene (PP) film, a polyester film and the like can be mentioned. In order to prevent cohesive failure of the adhesive layer when the protective film layer is peeled off, it is preferable that the protective film layer have a low adhesive force to the adhesive layer.

Then, a method for producing a substrate workpiece including the laminate film for temporary bonding of the present invention will be described. The substrate workpiece can be produced by a method including the steps of peeling off the protective film layer (A) from the laminate film for temporary bonding of the present invention, and placing the laminate film for temporary bonding from which the protective film layer (A) has been peeled off on (D) a semiconductor circuit formation substrate so that the laminate film for temporary bonding comes into contact with the semiconductor circuit formation substrate (D) with the adhesive layer (B) placed in between, and laminating the laminate film for temporary bonding on the semiconductor circuit formation substrate (D) by thermocompression bonding such as hot pressing, thermal lamination, or vacuum thermal lamination.

In order to avoid the generation of voids between the semiconductor circuit formation substrate and the adhesive layer, vacuum lamination is preferable, and vacuum roll lamination is more preferable.

Further, in the case of producing a substrate workpiece using an uneven semiconductor circuit formation substrate, it is preferable to press the substrate workpiece after the vacuum lamination. In general, in the case of directly applying an adhesive coating material to an uneven semiconductor circuit formation substrate, there are problems that the surface of the produced coating film is uneven following the unevenness of the substrate, and voids remain in the uneven portion. In contrast, use of the laminate film for temporary bonding is preferable because a flat resin film is formed and voids on the substrate can be suppressed.

Then, a method for producing a laminate substrate workpiece including the laminate film for temporary bonding of the present invention will be described. A substrate workpiece intermediate is produced by the steps of peeling off the protective film layer (A) from the laminate film for temporary bonding of the present invention, and placing the laminate film for temporary bonding from which the protective film layer (A) has been peeled off on either one of (D) a semiconductor circuit formation substrate and (E) a support substrate so that the laminate film for temporary bonding comes into contact with the semiconductor circuit formation substrate (D) or the support substrate (E) with the adhesive layer (B) placed in between, and laminating the laminate film for temporary bonding on the semiconductor circuit formation substrate (D) or the support substrate (B) by thermocompression bonding such as hot pressing, thermal lamination, or vacuum thermal lamination. As the support substrate, a silicon substrate, a glass substrate, a plastic substrate such as a polyimide substrate, or the like can be used.

Then, the laminate substrate workpiece can be produced by the step of peeling off the support film layer (C) from the substrate workpiece intermediate, placing the other one of the semiconductor circuit formation substrate (D) and the support substrate (E) on the substrate workpiece intermediate so that the substrate comes into contact with the adhesive layer (B), and laminating the substrate workpiece intermediate on the substrate by thermocompression bonding such as hot pressing, thermal lamination, or vacuum thermal lamination. In order to avoid the generation of voids between the semiconductor circuit formation substrate (D) or the support substrate (E) and the adhesive layer (B) during the production of the substrate workpiece intermediate, vacuum lamination is preferable, and vacuum roll lamination is more preferable.

Further, in the case of producing a laminate substrate workpiece using an uneven semiconductor circuit formation substrate, it is preferable to peel off the protective film layer from the laminate film for temporary bonding of the present invention, and placing the laminate film for temporary bonding that does not include the protective film on an uneven semiconductor circuit formation substrate so that the adhesive layer comes into contact with the semiconductor circuit formation substrate, subjecting the resulting laminate to vacuum lamination, and then subjecting the laminate to pressing. In this case, the substrate workpiece intermediate may be subjected to pressing after the substrate workpiece intermediate is subjected to vacuum lamination and the support film layer is peeled off. Further, the substrate workpiece intermediate may be subjected to heat treatment after the support film layer is peeled off from the substrate workpiece intermediate. When the adhesive layer contains a volatile component such as a solvent, it is preferable from the viewpoint of suppressing voids to remove the volatile component contained in the adhesive layer by heat treatment after peeling off the support film layer from the substrate workpiece intermediate.

In general, in the case of directly applying an adhesive coating material to an uneven semiconductor circuit formation substrate, there are problems that the surface of the produced coating film is uneven following the unevenness of the substrate, and voids remain in the uneven portion. In contrast, use of the laminate film for temporary bonding is preferable because a flat resin film is formed and voids on the substrate can be suppressed. Further, in the case of directly applying an adhesive coating material to a semiconductor circuit formation substrate, a film which is thick only at the periphery of the edge portion of the substrate is formed, and the edge portion is ridged. Therefore, when substrates are bonded to each other, bonding defects may occur at the periphery of the substrate. In contrast, when the laminate film for temporary bonding is used, the adhesive layer can be formed without any ridge even at the periphery of the substrate, and the substrates can be bonded to each other satisfactorily.

After a substrate workpiece is produced by the method of the present invention for producing a substrate workpiece using the laminate film for temporary bonding of the present invention, a semiconductor device can be produced. Moreover, after a laminate substrate workpiece is produced by the method of the present invention for producing a laminate substrate workpiece using the laminate film for temporary bonding of the present invention, a semiconductor device can be produced. The semiconductor device is produced, for example, by laminating semiconductor chips while connecting the semiconductor chips with a through-silicon via (TSV) in order to achieve higher levels of integration and higher packaging density of semiconductor elements. A silicon substrate is generally used as the semiconductor circuit formation substrate.

Then, a method for producing a semiconductor device using a substrate workpiece will be described. The method for producing a semiconductor device using a substrate workpiece includes at least one of the steps of: thinning the semiconductor circuit formation substrate, subjecting the semiconductor circuit formation substrate to device processing, peeling off the support film layer and the adhesive layer from the semiconductor circuit formation substrate, and washing off the adhesive layer attached to the semiconductor circuit formation substrate with a solvent. The step of thinning the semiconductor circuit formation substrate refers to a step of polishing or grinding the semiconductor circuit formation substrate side of the substrate workpiece by back grinding or the like to thin the semiconductor circuit formation substrate. It is possible to reduce the thickness of the semiconductor circuit formation substrate to 1 μm or more and 100 μm or less using a support film layer excellent in flexibility and strength.

The step of subjecting the semiconductor circuit formation substrate to device processing refers to a step of subjecting the semiconductor circuit formation substrate in the substrate workpiece to device processing by a plasma CVD step, a plasma PVD step, a sintering step, or the like. A polyimide film or the like excellent in heat resistance, which is used as the support film layer, can be used in the device processing step in which such heat treatment is performed. In this step, the semiconductor circuit formation substrate may be heated at 200° C. or higher.

The step of peeling off the support film layer and the adhesive layer from the semiconductor circuit formation substrate refers to a step of peeling off the support film layer and the adhesive layer from the substrate workpiece by a peeling and removing step or the like. The peeling and removing step may be performed while heating the substrate workpiece with a hot plate or the like. In addition, before the peeling and removing step, the substrate workpiece may be irradiated with a laser, ultraviolet rays or the like.

The step of washing off the adhesive layer attached to the semiconductor circuit formation substrate with a solvent refers to a step of washing off the adhesive layer attached to the semiconductor circuit formation substrate by spray coating of a solvent or immersion in a solvent after the peeling and removing step. The solvent for dissolving the attached adhesive layer may be various solvents, amine solvents such as monoethanolamine, solutions containing additives such as tetramethylammonium hydroxide, mixed solvents thereof, and the like. Any solvent remaining on the substrate may be removed by rinsing with pure water or a volatile solvent such as acetone or isopropyl alcohol. Further, after the washing, the substrate may be dried with an oven, a hot air dryer, or the like.

Then, a method for producing a semiconductor device using a laminate substrate workpiece will be described. The method for producing a semiconductor device using a laminate substrate workpiece includes at least one of the steps of: thinning the semiconductor circuit formation substrate, subjecting the semiconductor circuit formation substrate to device processing, peeling off the support substrate from the semiconductor circuit formation substrate, and washing off, with a solvent, the adhesive layer attached to the semiconductor circuit formation substrate or the support substrate that has been peeled off from the laminate substrate workpiece. The step of thinning the semiconductor circuit formation substrate refers to a step of polishing or grinding the semiconductor circuit formation substrate side of the laminate substrate workpiece by back grinding or the like to thin the semiconductor circuit formation substrate. Since the semiconductor circuit formation substrate is adhered well to the support substrate via the adhesive layer, the thickness of the semiconductor circuit formation substrate can be reduced to 1 μm or more and 100 μm or less.

The step of subjecting the semiconductor circuit formation substrate to device processing refers to a step of subjecting the semiconductor circuit formation substrate in the laminate substrate workpiece to device processing by a plasma CVD step, a plasma PVD step, a sintering step, or the like. Since the adhesive layer is excellent in heat resistance, the semiconductor circuit formation substrate may be heated at 200° C. or higher in this step.

The step of peeling off the support substrate from the semiconductor circuit formation substrate refers to a step of peeling off the support substrate from the semiconductor circuit formation substrate by subjecting the laminate substrate workpiece to a thermal slide peeling method, a laser irradiation peeling method, a mechanical peeling method, a solvent peeling method, an ultraviolet irradiation peeling method, or the like. In this case, the support substrate may be peeled off with the semiconductor circuit formation substrate being fixed to a tape such as a dicing tape, or the semiconductor circuit formation substrate may be peeled off with the support substrate being fixed to a tape such as a dicing tape.

The thermal slide peeling method refers to a method of peeling off the semiconductor circuit formation substrate while applying a temperature of 100 to 200° C. The laser irradiation peeling method refers to a method of reducing the adhesive force by laser irradiation to peel off the semiconductor circuit formation substrate. The mechanical peeling method refers to a method of gradually mechanically peeling off the semiconductor circuit formation substrate from an end of the substrate. The solvent peeling method refers to a method of immersing the laminate substrate workpiece in a solvent to dissolve the adhesive layer, and peeling off the semiconductor circuit formation substrate.

The step of washing off, with a solvent, the adhesive layer attached to the semiconductor circuit formation substrate or the support substrate that has been peeled off from the laminate substrate workpiece refers to a step of peeling off the semiconductor circuit formation substrate or the support substrate by the above-mentioned method, and then washing off the adhesive layer attached to the semiconductor circuit formation substrate or the support substrate by spray coating of a solvent or immersion in a solvent. The solvent for dissolving the attached adhesive layer may be various solvents, amine solvents such as monoethanolamine, solutions containing additives such as tetramethylammonium hydroxide, mixed solvents thereof, and the like. Any solvent remaining on the substrate may be removed by rinsing with pure water or a volatile solvent such as acetone or isopropyl alcohol. Further, after the washing, the substrate may be dried with an oven, a hot air dryer, or the like.

### EXAMPLES

In the following, the present invention will be described by way of examples. The present invention is not limited to these examples.

<Measurement of Glass Transition Temperature>

A polyimide solution was applied in a thickness of 20 μm to a gloss surface of an 18 μm-thick electrolytic copper foil piece with a bar coater, and then dried at 80° C. for 10 minutes and at 150° C. for 10 minutes. The solution was then heated at 250° C. for 10 minutes in a nitrogen atmosphere to give a polyimide-laminated copper foil piece. Then, the whole surface of the copper foil of the obtained polyimide-laminated copper foil piece was etched with a ferric chloride solution to give a single film of polyimide.

About 10 mg of the obtained single film of polyimide was placed in an aluminum standard container and measured with a differential scanning calorimeter DSC-50 (manufactured by Shimadzu Corporation). The glass transition temperature (hereinafter referred to as “Tg”) was calculated from the inflection point of the obtained DSC curve. The single film was preliminarily dried at 80° C. for 1 hour, and then the measurement was performed at a heating rate of 20° C./min.

<Measurement of Thickness>

The thickness of an adhesive layer formed on a support film layer was measured with DIGIMICRO MFC-101 (manufactured by NIKON CORPORATION).

<Evaluation of Edge Portion>

The film thickness of a 6-inch silicon wafer was measured with a surface roughness tester SURFCOM 1400D (manufactured by TOKYO SEIMITSU CO., LTD.). As for the points of measurement of the film thickness, the film thickness at the center of the wafer (film thickness 1) and the film thickness at the point of maximum thickness within the range of 2 cm from the wafer edge (film thickness 2) were measured. The ratio of the film thickness 2 to the film thickness 1 (hereinafter referred to as “raised multiple”) was evaluated. As for the evaluation criteria, the silicon wafer was evaluated as good in flatness when the raised multiple was less than 1.2, and was evaluated as poor in flatness when the raised multiple was 1.2 or more.

<Evaluation of Heat Resistance>

A laminate having a glass substrate laminated thereon was heated at 350° C. for 2 hours, and then visually observed from the glass side for the evaluation of the presence or absence of voids. The evaluation criteria are as follows.

A: No voids

B: Voids of 1 cm or less

<Evaluation of Substrate Peeling>

One of silicon substrates of a laminate substrate workpiece was fixed to a desk, and the other silicon substrate was peeled off by lifting one point of a glass substrate with tweezers at room temperature. The evaluation criteria are as follows.

A: Peelable

B: Not peelable

<Rework Evaluation>

An adhesive layer attached to the silicon substrate peeled off in the evaluation of substrate peeling was reworked at 23° C. for 10 minutes with the rework solvent obtained in Production Example 17, and the solubility of the adhesive layer was visually observed. The evaluation criteria are as follows.

A: No residue of the adhesive layer

B: The adhesive layer was dissolved, but a residue remained on the substrate

<Measurement of Thermal Decomposition Temperature of Support Film Layer>

A support film layer was heated with a TGA (EXSTER 6000 (manufactured by Seiko Instruments Inc.)) to 450° C. at 5° C./min in an air atmosphere, and the 1% weight loss temperature of the support film layer was measured.

<Measurement of Melting Point of Support Film Layer>

DSC measurement of a support film layer was performed, and the peak top of the melting peak in the obtained DSC curve was taken as the melting point. The DSC measurement was performed with DSC 6220 (manufactured by Seiko Instruments Inc.), and the measurement conditions were a nitrogen atmosphere and a heating rate of 20° C./min.

<Back Grinding Evaluation of Silicon Substrate>

A substrate workpiece was set on a grinder DAG810 (manufactured by DISCO Corporation), and a silicon substrate was polished to a thickness of 100 μm. The silicon substrate after grinding was visually observed, and the presence or absence of fractures or cracks was evaluated.

<Evaluation of Peeling of Support Film Layer>

A dicing tape UHP-1005MS (manufactured by Denka Company Limited) was attached to a silicon substrate side of a substrate workpiece with a tape applicator FM-114 (manufactured by Technovision, Inc.), and the substrate workpiece was fixed to a dicing frame. One point in the wafer edge portion of the support film layer of the substrate workpiece was lifted with tweezers, and the support film layer was peeled off from the silicon substrate.

<Measurement of Average Molecular Weight of Polysiloxane Diamine and Calculation of Numerical Values of m and n>

Polysiloxane diamine (5 g) as a sample was taken in a beaker, and 50 ml of a 1:1 mixed solution of IPA and toluene was added to the beaker to dissolve the polysiloxane diamine. Then, using an automatic potentiometric titrator AT-610 manufactured by Kyoto Electronics Manufacturing Co., Ltd., a 0.1 N aqueous hydrochloric acid solution was added dropwise with stirring to the resulting solution, and the amount of the aqueous solution added until the neutralization point was determined. The average molecular weight was calculated from the amount of the added 0.1 N aqueous hydrochloric acid solution according to the following formula.

2×[10×36.5×(amount of added aqueous solution (g))]/5=average molecular weight

Then, the molecular weights of the polysiloxane diamine used were calculated from its chemical structural formula for the cases of n=1 and n=10, and a relationship between the value of n and the molecular weight was obtained as a relational expression of a linear function. The average value of n was determined by applying the average of the molecular weights to the relational expression. m was calculated by the same method.

<Surface Energy Evaluation>

Using an automatic contact angle meter (DM-500 (manufactured by Kyowa Interface Science Co., Ltd.)), 1 μL of pure water was placed on a support film layer, and the contact angle was measured after 80 seconds. Similarly, 1 μL of diiodomethane was placed on the support film layer, and the contact angle was measured after 80 seconds. The surface energy was calculated according to the Owens-Wendt equation using the contact angles when pure water and diiodomethane were used.

Names of abbreviations of acid dianhydrides, diamines, fillers, and solvents shown in the following production examples are as follows.

ODPA: 3,3′,4,4′-diphenyl ether tetracarboxylic dianhydride

APPS1: α,ω-bis(3-aminopropyl)polydimethylsiloxane

(average molecular weight: 860, the structure of the general formula (1) wherein m=9, the structure of the general formula (3) wherein n=9)

APPS2: α,ω-bis (3-aminopropyl)polydimethylsiloxane

(average molecular weight: 1600, the structure of the general formula (1) wherein m=19, the structure of the general formula (3) wherein n=19)

APPS3: α,ω-bis(3-aminopropyl)polydimethylsiloxane

(average molecular weight: 4400, the structure of the general formula (1) wherein m=57, the structure of the general formula (3) wherein n=57)

44DAE: 4,4′-diaminodiphenyl ether

APB: 1,3-bis (3-aminophenoxy)benzene

SiDA: 1,1,3,3-tetramethyl-1,3-bis (3-aminopropyl)disiloxane

(molecular weight: 248, the structure of the general formula (1) wherein m=1, the structure of the general formula (3) wherein n=1)

MEK-ST-40: inorganic fine particle-containing liquid

(silica dispersed in MEK solvent, silica concentration: 40% by mass, average particle diameter: 12 nm)

(manufactured by Nissan Chemical Industries, Ltd.)

DMM: dipropylene glycol dimethyl ether

KBM-1003: vinylsilane (manufactured by Shin-Etsu Chemical Co., Ltd.)

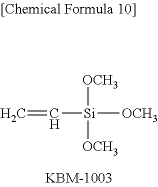

### Synthesis Example 1

### (1b)-1 Siloxane Compound Solution

Into a reaction kettle equipped with a thermometer, a dry nitrogen inlet, a heating/cooling unit that operates with warm water/cooling water, and a stirrer, 1600.0 g (1.0 mol) of APPS2 was charged together with 1896.2 g of DMM, and dissolved. To the resulting solution, 296.2 g (2.0 mol) of phthalic anhydride was added, and the resulting mixture was reacted at room temperature for 1 hour, and then at 60° C. for 5 hours to give a 50% by mass siloxane compound solution ((1b)-1).

### Synthesis Examples 2 and 3

### Siloxane Compound Solution

The same operation as in Synthesis Example 1 was performed except that the types and charged amounts of the siloxane diamine and the phthalic anhydride compound were changed as shown in Table 1 to give 50% by mass siloxane compound solutions ((1b)-2 and (1b)-3).

TABLE 1

| | | | | Terminal blocking agent | | |
|---|---|---|---|---|---|---|
| | | Siloxane | | | 4-tert-Butyl | Solvent |
| Siloxane compound solution | | diamine | | Phthalic | phthalic | (g) |
| (concentration: 50% by mass) | | APPS2 | APPS3 | anhydride | anhydride | DMM |
| Synthesis | (1b)-1 | 100 | — | 200 | — | 1896.2 |
| Example 1 | | 1600.0 | — | 296.2 | — | |
| Synthesis | (1b)-2 | — | 100 | — | 200 | 4808.4 |
| Example 2 | | — | 4400 | — | 408.4 | |
| Synthesis | (1b)-3 | — | 100 | 200 | — | 4696.2 |
| Example 3 | | — | 4400.0 | 296.2 | — | |

In Table 1, for the siloxane diamine and the terminal blocking agent, the upper row shows the percentage (mol %), and the lower row shows the content (g).

### Synthesis Example 4

### Monosilyl Compound

Into a 500-ml flask, 500 g of hexane was charged, and 21.33 g (0.1 mol) of aminophenyltrimethoxysilane (a mixture of 3-aminophenyltrimethoxysilane and 4-aminophenyltrimethoxysilane at a weight ratio of 6:4) was added to the flask. Then, 10.21 g (0.1 mol) of acetic anhydride was added dropwise slowly, and the resulting mixture was reacted at room temperature for 3 hours. The resultant precipitate was separated by filtration and dried to give a monosilyl compound (hereinafter abbreviated as AcAPMS) represented by the following formula.

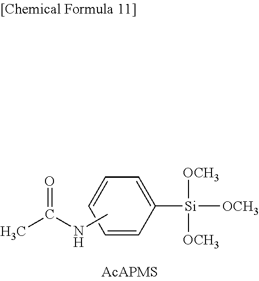

### Synthesis Example 5

### Polyimide Resin Solution

Into a reaction kettle equipped with a thermometer, a dry nitrogen inlet, a heating/cooling unit that operates with warm water/cooling water, and a stirrer, 602.0 g (0.7 mol) of APPS1 and 60.1 g (0.3 mol) of 44DAE were charged together with 972.3 g of DMM, and dissolved. To the resulting solution, 310.2 g (1 mol) of ODPA was added, and the resulting mixture was reacted at room temperature for 1 hour, then at 60° C. for 1 hour, and then at 150° C. for 4 hours. Then, the concentration of the reaction product was adjusted with the solvent DMM to give a 50% by mass polyimide resin solution ((b1)-1). Tg measurement was performed using the obtained polyimide resin solution. As a result, the Tg was 30° C.

### Synthesis Examples 6 to 8

### Polyimide Resin Solution

The same operation as in Synthesis Example 5 was performed except that the types and charged amounts of the acid dianhydride and the diamine were changed as shown in Table 1 to give 50% by mass polyimide resin solutions (b1)-2, (b1)-3, and (b1)-4, and Tg measurement was performed.

TABLE 2

| | | Acid | Diamine | | | | Solvent | |
|---|---|---|---|---|---|---|---|---|
| Polyimide resin solution | | dianhydride | Siloxane | | Aromatic | | (g) | Tg |
| (concentration: 50% by mass) | | ODPA | APPS1 | APPS2 | 44DAE | APB | DMM | (° C.) |
| Synthesis | (b1)-1 | 100 | 70 | — | 30 | — | 972.3 | 30 |
| Example 5 | | 310.2 | 602.0 | — | 60.1 | — | | |
| Synthesis | (b1)-2 | 100 | — | 70 | 30 | — | 1490.3 | 19 |
| Example 6 | | 310.2 | — | 1120.0 | 60.1 | — | | |
| Synthesis | (b1)-3 | 100 | — | 30 | 70 | — | 930.4 | 130 |
| Example 7 | | 310.2 | — | 480.0 | 140.2 | — | | |
| Synthesis | (b1)-4 | 100 | 70 | — | — | 30 | 999.9 | 16 |
| Example 8 | | 310.2 | 602.0 | — | — | 87.7 | | |

In Table 2, for the acid dianhydride and the diamine, the upper row shows the percentage (mol %), and the lower row shows the content (g).

### Production Example 1

### Preparation of Adhesive Coating Material

Into a reaction kettle equipped with a stirrer, 10.0 g of a 50% by mass solution of APPS3 (solvent: DMM), 5.0 g of AcAPMS obtained in Synthesis Example 4, 200.0 g of the polyimide resin solution ((b1)-1) obtained in Synthesis Example 5, and 12.0 g of the inorganic fine particle-containing liquid MEK-ST-40 were charged, and stirred at room temperature for 2 hours to give an adhesive coating material (CM1).

### Production Examples 2 to 16

### Preparation of Adhesive Coating Material

The same operation as in Production Example 1 was performed except that the charged amounts of the siloxane polymer represented by the general formula (1), the compound represented by the general formula (2), the polyimide resin solution, and the inorganic fine particle-containing liquid MEK-ST-40 were changed as shown in Table 3 to give adhesive coating materials (CM2 to 16).

TABLE 3

| | | | | | | | | Inorganic fine particle- | |
|---|---|---|---|---|---|---|---|---|---|
| | | Siloxane compound | | | | Polyimide resin | | containing liquid | |
| | | solution (concentration: | | Monosilyl | | solution (concentration: | | (silica concentration: | |
| | | 50% by mass) | | compound | | 50% by mass) | | 40% by mass) | |
| | | | Charged | | Charged | | Charged | | Charged |
| | | | amount | | amount | | amount | | amount |
| Adhesive coating material | | Type | (g) | Type | (g) | Type | (g) | Type | (g) |
| Production Example 1 | CM1 | APPS3 | 10.0 | AcAPMS | 5.0 | (b1)-1 | 200.0 | MEK-ST-40 | 12.0 |
| Production Example 2 | CM2 | APPS3 | 10.0 | AcAPMS | 5.0 | (b1)-2 | 200.0 | MEK-ST-40 | 12.0 |
| Production Example 3 | CM3 | APPS3 | 10.0 | AcAPMS | 5.0 | (b1)-3 | 200.0 | MEK-ST-40 | 12.0 |
| Production Example 4 | CM4 | APPS3 | 10.0 | AcAPMS | 5.0 | (b1)-4 | 200.0 | MEK-ST-40 | 12.0 |
| Production Example 5 | CM5 | (1b)-1 | 10.0 | AcAPMS | 5.0 | (b1)-1 | 200.0 | MEK-ST-40 | 12.0 |
| Production Example 6 | CM6 | (1b)-2 | 10.0 | AcAPMS | 5.0 | (b1)-1 | 200.0 | MEK-ST-40 | 12.0 |
| Production Example 7 | CM7 | (1b)-3 | 10.0 | AcAPMS | 5.0 | (b1)-1 | 200.0 | MEK-ST-40 | 12.0 |
| Production Example 8 | CM8 | APPS2 | 10.0 | AcAPMS | 5.0 | (b1)-1 | 200.0 | MEK-ST-40 | 12.0 |
| Production Example 9 | CM9 | APPS3 | 1.0 | AcAPMS | 5.0 | (b1)-1 | 200.0 | MEK-ST-40 | 12.0 |
| Production Example 10 | CM10 | APPS3 | 10.0 | AcAPMS | 1.0 | (b1)-1 | 200.0 | MEK-ST-40 | 12.0 |
| Production Example 11 | CM11 | APPS3 | 10.0 | — | — | (b1)-1 | 200.0 | MEK-ST-40 | 12.0 |
| Production Example 12 | CM12 | — | — | AcAPMS | 5.0 | (b1)-1 | 200.0 | MEK-ST-40 | 12.0 |
| Production Example 13 | CM13 | — | — | — | — | (b1)-1 | 200.0 | MEK-ST-40 | 12.0 |
| Production Example 14 | CM14 | — | — | — | — | (b1)-4 | 200.0 | MEK-ST-40 | 12.0 |
| Production Example 15 | CM15 | SiDA | 10.0 | — | — | (b1)-1 | 200.0 | MEK-ST-40 | 12.0 |
| Production Example 16 | CM16 | — | — | KBM-1003 | 5.0 | (b1)-1 | 200.0 | MEK-ST-40 | 12.0 |

### Production Example 17

### Preparation of Rework Solvent

Into a reaction kettle equipped with a stirrer, 30 g of monoethanolamine, 30 g of DMM, and 30 g of N-methyl-2-pyrrolidone were charged, and stirred at room temperature for 1 hour to give a rework solvent.

### Example 1

The adhesive coating material (CM1) obtained in Production Example 1 was applied to a support film layer SR7 (thickness: 75 μm, a polyester film, manufactured by OHTSUKI INDUSTRIAL CO., LTD.) with a bar coater, and dried at 100° C. for 10 minutes. Then, SR7 (manufactured by OHTSUKI INDUSTRIAL CO., LTD.) was laminated thereon as a protective film layer to give a laminate film (S1) for temporary bonding having an adhesive layer thickness of 15 μm (the percentage of the siloxane compound APPS3 in the adhesive layer of the laminate film (S1) for temporary bonding was about 4.3% by mass, and the percentage of the monosilyl compound AcAPMS in the adhesive layer was about 4.3% by mass).

### Examples 2 to 12

In the same manner as in Example 1, each of the adhesive coating materials (CM2 to 12) was applied to the support film layer SR7 (thickness: 75 μm, a polyester film, manufactured by OHTSUKI INDUSTRIAL CO., LTD.), and dried at 100° C. for 10 minutes. Then, SR7 (manufactured by OHTSUKI INDUSTRIAL CO., LTD.) was laminated thereon as a protective film layer to give each laminate film (S2 to S12) for temporary bonding having an adhesive layer thickness of 15 μm.

### Example 13

The protective film layer of the laminate film (S1) for temporary bonding obtained in Example 1 was peeled off, and then the laminate film (S1) for temporary bonding was laminated on a 6-inch silicon substrate (thickness: 645 μm) with a vacuum laminator VTM-200M (manufactured by Takatori Corporation) so that the adhesive layer would come into contact with the silicon substrate. The lamination conditions were a heater temperature of 100° C., a roll temperature of 100° C., a lamination speed of 5 mm/sec, a lamination roll pressure of 0.2 MPa, and a chamber pressure of 150 Pa. The support film layer of the obtained laminate was peeled off to give a laminated substrate (K1). The raised multiple of the laminated substrate (K1) was measured and found to be 1.0.

### Example 14

The protective film layer of the laminate film (S2) for temporary bonding obtained in Example 2 was peeled off, and then the laminate film (S2) for temporary bonding was laminated on a 6-inch silicon substrate (thickness: 645 μm) with a vacuum laminator VTM-200M (manufactured by Takatori Corporation) so that the adhesive layer would come into contact with the silicon substrate. The lamination conditions were a heater temperature of 100° C., a roll temperature of 100° C., a lamination speed of 5 mm/sec, a lamination roll pressure of 0.2 MPa, and a chamber pressure of 150 Pa. The support film layer of the obtained laminate was peeled off to give a laminated substrate (K2). The raised multiple of the laminated substrate (K2) was measured and found to be 1.0.

### Example 15

The protective film layer of the laminate film (S3) for temporary bonding obtained in Example 3 was peeled off, and then the laminate film (S3) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 150° C., a pressing force of 0.2 MPa, a vacuum time of 30 seconds, and a pressing time of 30 seconds. The support film layer of the obtained laminate was peeled off to give a laminated substrate (K3). The raised multiple of the laminated substrate (K3) was measured and found to be 1.0.

### Example 16

The protective film layer of the laminate film (S4) for temporary bonding obtained in Example 4 was peeled off, and then the laminate film (S4) for temporary bonding was laminated on a 6-inch silicon substrate (thickness: 645 μm) with a vacuum laminator VTM-200M (manufactured by Takatori Corporation) so that the adhesive layer would come into contact with the silicon substrate. The lamination conditions were a heater temperature of 100° C., a roll temperature of 100° C., a lamination speed of 5 mm/sec, a lamination roll pressure of 0.2 MPa, and a chamber pressure of 150 Pa. The support film layer of the obtained laminate was peeled off to give a laminated substrate (K4). The raised multiple of the laminated substrate (K4) was measured and found to be 1.0.

### Comparative Examples 1 to 4

In the same manner as in Example 1, each of the adhesive coating materials (CM13 to 16) was applied to the polyester film SR7 having a thickness of 75 μm (manufactured by OHTSUKI INDUSTRIAL CO., LTD.), and dried at 100° C. for 10 minutes. Then, SR7 (manufactured by OHTSUKI INDUSTRIAL CO., LTD.) was laminated thereon as a protective film layer to give each laminate film (S13 to S16) for temporary bonding having an adhesive layer thickness of 15 μm.

### Comparative Example 5

The adhesive coating material (CM13) was applied to a 6-inch silicon substrate (thickness: 645 μm) with a spin coater with the number of revolutions of the spin coater being adjusted, and dried on a hot plate at 100° C. for 10 minutes, so that a substrate having an adhesive layer thickness of 15 μm was obtained. The raised multiple of the obtained substrate was measured and found to be 2.1.

### Comparative Example 6

In the same manner as in Comparative Example 5, the adhesive coating material (CM14) was applied to a 6-inch silicon substrate (thickness: 645 μm) with a spin coater with the number of revolutions of the spin coater being adjusted, and dried on a hot plate at 100° C. for 10 minutes, so that a substrate having an adhesive layer thickness of 15 μm was obtained. The raised multiple of the obtained substrate was measured and found to be 2.0.

### Comparative Example 7

In the same manner as in Comparative Example 5, the adhesive coating material (CM15) was applied to a 6-inch silicon substrate (thickness: 645 μm) with a spin coater with the number of revolutions of the spin coater being adjusted, and dried on a hot plate at 100° C. for 10 minutes, so that a substrate having an adhesive layer thickness of 15 μm was obtained. The raised multiple of the obtained substrate was measured and found to be 2.0.

### Comparative Example 8

In the same manner as in Comparative Example 5, the adhesive coating material (CM16) was applied to a 6-inch silicon substrate (thickness: 645 μm) with a spin coater with the number of revolutions of the spin coater being adjusted, and dried on a hot plate at 100° C. for 10 minutes, so that a substrate having an adhesive layer thickness of 15 μm was obtained. The raised multiple of the obtained substrate was measured and found to be 2.1.

### Example 17

The laminated substrate (K1) obtained by the same operation as in Example 13 was heated at 350° C. for 1 hour to give a heated substrate (N1). The adhesive layer of the obtained substrate and a glass substrate (thickness: 1.3 mm, length: 76 mm, width: 52 mm) were superimposed on each other, and laminated with a vacuum laminator CVP300T (manufactured by Nichigo-Morton Co., Ltd.). The lamination conditions were upper and lower heating plate temperatures of 180° C., a pressing force of 0.3 MPa, a vacuum time of 30 seconds, and a pressing time of 30 seconds. The heat resistance of the obtained substrate was evaluated, and the results are summarized in Table 4.

In addition, after the heated substrate (N1) was produced, in the same manner as described above, the heated substrate (N1) and another 6-inch silicon substrate were superimposed on each other so that the adhesive layer would come into contact with the silicon substrate, and the resulting laminate was compression-bonded at a load of 1000 N for 3 minutes with a hot press having upper and lower plates each set at 200° C. to give a laminate substrate workpiece. Using the obtained laminate substrate workpiece, evaluation of substrate peeling and rework evaluation were performed, and the results are summarized in Table 4.

### Example 18

The laminated substrate (K2) obtained by the same operation as in Example 14 was heated at 350° C. for 1 hour to give a heated substrate (N2). The adhesive layer of the obtained substrate and a glass substrate (thickness: 1.3 mm, length: 76 mm, width: 52 mm) were superimposed on each other, and laminated with a vacuum laminator CVP300T (manufactured by Nichigo-Morton Co., Ltd.). The lamination conditions were upper and lower heating plate temperatures of 180° C., a pressing force of 0.3 MPa, a vacuum time of 30 seconds, and a pressing time of 30 seconds. The heat resistance of the obtained substrate was evaluated, and the results are summarized in Table 4.

In addition, after the heated substrate (N2) was produced, in the same manner as described above, the heated substrate (N2) and another 6-inch silicon substrate were superimposed on each other so that the adhesive layer would come into contact with the silicon substrate, and the resulting laminate was compression-bonded at a load of 1000 N for 3 minutes with a hot press having upper and lower plates each set at 200° C. to give a laminate substrate workpiece. Using the obtained laminate substrate workpiece, evaluation of substrate peeling and rework evaluation were performed, and the results are summarized in Table 4.

### Example 19

The laminated substrate (K3) obtained by the same operation as in Example 15 was heated at 350° C. for 1 hour to give a heated substrate (N3). The adhesive layer of the obtained substrate and a glass substrate (thickness: 1.3 mm, length: 76 mm, width: 52 mm) were superimposed on each other, and laminated with a vacuum laminator CVP300T (manufactured by Nichigo-Morton Co., Ltd.). The lamination conditions were upper and lower heating plate temperatures of 180° C., a pressing force of 0.3 MPa, a vacuum time of 30 seconds, and a pressing time of 30 seconds. The heat resistance of the obtained substrate was evaluated, and the results are summarized in Table 4.

In addition, after the heated substrate (N3) was produced, in the same manner as described above, the heated substrate (N3) and another 6-inch silicon substrate were superimposed on each other so that the adhesive layer would come into contact with the silicon substrate, and the resulting laminate was compression-bonded at a load of 1000 N for 3 minutes with a hot press having upper and lower plates each set at 200° C. to give a laminate substrate workpiece. Using the obtained laminate substrate workpiece, evaluation of substrate peeling and rework evaluation were performed, and the results are summarized in Table 4.

### Example 20

The laminated substrate (K4) obtained by the same operation as in Example 16 was heated at 350° C. for 1 hour to give a heated substrate (N4). The adhesive layer of the obtained substrate and a glass substrate (thickness: 1.3 mm, length: 76 mm, width: 52 mm) were superimposed on each other, and laminated with a vacuum laminator CVP300T (manufactured by Nichigo-Morton Co., Ltd.). The lamination conditions were upper and lower heating plate temperatures of 180° C., a pressing force of 0.3 MPa, a vacuum time of 30 seconds, and a pressing time of 30 seconds. The heat resistance of the obtained substrate was evaluated, and the results are summarized in Table 4.

In addition, after the heated substrate (N4) was produced, in the same manner as described above, the heated substrate (N4) and another 6-inch silicon substrate were superimposed on each other so that the adhesive layer would come into contact with the silicon substrate, and the resulting laminate was compression-bonded at a load of 1000 N for 3 minutes with a hot press having upper and lower plates each set at 200° C. to give a laminate substrate workpiece. Using the obtained laminate substrate workpiece, evaluation of substrate peeling and rework evaluation were performed, and the results are summarized in Table 4.

### Examples 21 to 28

Using the laminate films (S5 to S12) for temporary bonding produced in Examples 5 to 12, laminated substrates (K5 to K12) were respectively produced in the same manner as in Example 13, and heated at 350° C. for 1 hour to give heated substrates (N5 to N12). Using the obtained substrates, evaluation of heat resistance, evaluation of substrate peeling, and rework evaluation were performed in the same manner as in Example 17, and the results are summarized in Table 4.

### Comparative Examples 9 to 12

Using the laminate films (S13 to S16) for temporary bonding produced in Comparative Examples 1 to 4, laminated substrates (K13 to K16) were respectively produced in the same manner as in Example 13, and heated at 350° C. for 1 hour to give heated substrates (N13 to N16). Using the obtained substrates, evaluation of heat resistance, evaluation of substrate peeling, and rework evaluation were performed in the same manner as in Example 17, and the results are summarized in Table 4.

TABLE 4

| | | Siloxane compound | | | | | | | |
|---|---|---|---|---|---|---|---|---|---|
| | Laminate | solution | | Monosilyl compound | | | | | |
| | film for | | Percentage in | | Percentage in | Polyimide | Evaluation | | |
| | temporary | | adhesive layer | | adhesive layer | resin | of heat | Evaluation | Rework |
| | bonding | Type | (% by mass) | Type | (% by mass) | solution | resistance | of peeling | evaluation |
| Example 17 | S1 | APPS3 | 4.3 | AcAPMS | 4.3 | (b1)-1 | A | A | A |
| Example 18 | S2 | APPS3 | 4.3 | AcAPMS | 4.3 | (b1)-2 | A | A | A |
| Example 19 | S3 | APPS3 | 4.3 | AcAPMS | 4.3 | (b1)-3 | A | A | A |
| Example 20 | S4 | APPS3 | 4.3 | AcAPMS | 4.3 | (b1)-4 | A | A | A |
| Example 21 | S5 | (1b)-1 | 4.3 | AcAPMS | 4.3 | (b1)-1 | A | A | A |
| Example 22 | S6 | (1b)-2 | 4.3 | AcAPMS | 4.3 | (b1)-1 | A | A | A |
| Example 23 | S7 | (1b)-3 | 4.3 | AcAPMS | 4.3 | (b1)-1 | A | A | A |
| Example 24 | S8 | APPS2 | 4.3 | AcAPMS | 4.3 | (b1)-1 | A | A | A |
| Example 25 | S9 | APPS3 | 0.9 | AcAPMS | 4.5 | (b1)-1 | A | A | A |
| Example 26 | S10 | APPS3 | 4.5 | AcAPMS | 0.9 | (b1)-1 | A | A | A |

| | | | | | | | | |
|---|---|---|---|---|---|---|---|---|
| Example 27 | S11 | APPS3 | 4.6 | not added | (b1)-1 | A | A | A |

| | | | | | | | | |
|---|---|---|---|---|---|---|---|---|
| Example 28 | S12 | not added | AcAPMS | 4.6 | (b1)-1 | A | B | — |

| Comparative Example 9 | S13 | not added | | not added | (b1)-1 | B | B | — |
|---|---|---|---|---|---|---|---|---|
| Comparative Example 10 | S14 | not added | | not added | (b1)-4 | B | B | — |
| Comparative Example 11 | S15 | SiDA | 4.6 | not added | (b1)-1 | B | B | — |

| | | | | | | | | |
|---|---|---|---|---|---|---|---|---|
| Comparative Example 12 | S16 | not added | KBM-1003 | 4.6 | (b1)-1 | B | B | — |

### Example 29

The protective film layer of the laminate film (S12) for temporary bonding obtained in Example 12 was peeled off, and then the laminate film (S12) for temporary bonding was laminated on an 8-inch silicon substrate (thickness: 725 μm) with a vacuum laminator CVP300T (manufactured by Nichigo-Morton Co., Ltd.) so that the adhesive layer would come into contact with the silicon substrate. The lamination conditions were upper and lower heating plate temperatures of 100° C., a pressing force of 0.2 MPa, a vacuum time of 30 seconds, and a pressing time of 30 seconds. The support film layer was peeled off, and then the laminate was heated at 350° C. for 1 hour to give a heated substrate. The heated substrate was superimposed on an 8-inch alkali-free glass substrate with holes for the passage of the solvent so that the adhesive layer of the obtained heated substrate would come into contact with the alkali-free glass substrate, and the substrates were laminated with a vacuum laminator CVP300T (manufactured by Nichigo-Morton Co., Ltd.). The lamination conditions were upper and lower heating plate temperatures of 180° C., a pressing force of 0.3 MPa, a vacuum time of 30 seconds, and a pressing time of 30 seconds. The obtained substrate was immersed in the rework solvent produced in Production Example 17 at 23° C. for 30 minutes, and it was confirmed that the silicon substrate and the glass substrate can be peeled off from each other.

### Example 30

The adhesive coating material (CM1) obtained in Production Example 1 was applied to a support film layer 140EN-Y (thickness: 35 μm, 1% weight loss temperature: higher than 450° C., melting point: higher than 300° C., linear expansion coefficient: 5 ppm/° C., a polyimide film, manufactured by DU PONT-TORAY CO., LTD.) with a bar coater, and dried at 100° C. for 10 minutes. SR7 (manufactured by OHTSUKI INDUSTRIAL CO., LTD.) as a protective film layer was laminated thereon to give a laminate film (TS1) for temporary bonding having an adhesive layer thickness of 20 μm.

### Examples 31 and 32

The same operation as in Example 30 was performed using the adhesive coating materials (CM2 and CM4) respectively produced in Production Examples 2 and 4 instead of the adhesive coating material (CM1) to give laminate films (TS2 and TS4) for temporary bonding each having an adhesive layer thickness of 20 μm.

### Example 33

The same operation as in Example 30 was performed except that the support film layer 140EN-Y was changed to a support film layer 500V (thickness: 125 μm, melting point: higher than 300° C., linear expansion coefficient: 26 ppm/° C., a polyimide film, manufactured by DU PONT-TORAY CO., LTD.) to give a laminate film (TS5) for temporary bonding having an adhesive layer thickness of 20 μm.

### Example 34

The same operation as in Example 30 was performed except that the support film layer 140EN-Y was changed to a support film layer laminate (a laminate of two support film layers 140EN-Y, thickness: 80 μm, melting point: higher than 300° C., linear expansion coefficient: 6 ppm/° C., a polyimide film, manufactured by DU PONT-TORAY CO., LTD.) to give a laminate film (TS6) for temporary bonding having an adhesive layer thickness of 20 μm.

### Example 35

The protective film layer of the laminate film (TS1) for temporary bonding obtained in Example 30 was peeled off, and then the laminate film (TS1) for temporary bonding was laminated on a 6-inch silicon substrate (thickness: 645 μm) with a vacuum laminator VTM-200M (manufactured by Takatori Corporation) so that the adhesive layer would come into contact with the silicon substrate to give a substrate workpiece. The lamination conditions were a heater temperature of 100° C., a roll temperature of 100° C., a lamination speed of 5 mm/sec, a lamination roll pressure of 0.2 MPa, and a chamber pressure of 150 Pa. The obtained substrate workpiece was left standing at 240° C. for 5 minutes, and then left standing at 280° C. for 5 minutes. As a result, no change was observed in the support film layer.

### Example 36

The protective film layer of the laminate film (TS1) for temporary bonding obtained in Example 30 was peeled off, and then the laminate film (TS1) for temporary bonding was dried at 250° C. for 10 minutes. The laminate film (TS1) for temporary bonding was laminated on a 6-inch silicon substrate (thickness: 645 μm) with a vacuum laminator VTM-200M (manufactured by Takatori Corporation) so that the adhesive layer would come into contact with the silicon substrate to give a substrate workpiece (TK1). The lamination conditions were a heater temperature of 100° C., a roll temperature of 100° C., a lamination speed of 5 mm/sec, a lamination roll pressure of 0.2 MPa, and a chamber pressure of 150 Pa. The obtained substrate workpiece was left standing at 0.001 MPa and 240° C. for 60 minutes, and then left standing at 280° C. for 5 minutes. It was confirmed that no voids were generated. Further, evaluation of peeling of the support film layer was performed, and it was confirmed that the support film layer can be peeled off.

Example 37

The same operation as in Example 36 was performed except that the laminate film (TS1) for temporary bonding was changed to the laminate film (TS2) for temporary bonding obtained in Example 31 to give a substrate workpiece (TK2). The obtained substrate workpiece was left standing at 0.001 MPa and 240° C. for 60 minutes, and then left standing at 280° C. for 5 minutes. It was confirmed that no voids were generated. Further, evaluation of peeling of the support film layer was performed, and it was confirmed that the support film layer can be peeled off.

### Example 38

The same operation as in Example 36 was performed except that the laminate film (TS1) for temporary bonding was changed to the laminate film (TS4) for temporary bonding obtained in Example 32 to give a substrate workpiece (TK4). The obtained substrate workpiece was left standing at 0.001 MPa and 240° C. for 60 minutes, and then left standing at 280° C. for 5 minutes. It was confirmed that no voids were generated. Further, evaluation of peeling of the support film layer was performed, and it was confirmed that the support film layer can be peeled off.

### Example 39

The same operation as in Example 36 was performed except that the laminate film (TS1) for temporary bonding was changed to the laminate film (TS5) for temporary bonding obtained in Example 33 to give a substrate workpiece (TK5). The obtained substrate workpiece was left standing at 0.001 MPa and 240° C. for 60 minutes, and then left standing at 280° C. for 5 minutes. It was confirmed that no voids were generated. Further, evaluation of peeling of the support film layer was performed, and it was confirmed that the support film layer can be peeled off.

### Example 40

The same operation as in Example 36 was performed except that the laminate film (TS1) for temporary bonding was changed to the laminate film (TS6) for temporary bonding obtained in Example 34 to give a substrate workpiece (TK6). The obtained substrate workpiece was left standing at 0.001 MPa and 240° C. for 60 minutes, and then left standing at 280° C. for 5 minutes. It was confirmed that no voids were generated. Further, evaluation of peeling of the support film layer was performed, and it was confirmed that the support film layer can be peeled off.

### Example 41

The protective film layer of the laminate film (TS1) for temporary bonding obtained in Example 30 was peeled off, and then the laminate film (TS1) for temporary bonding was dried at 250° C. for 10 minutes. The laminate film (TS1) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate to give a substrate workpiece (TK7). The lamination conditions were upper and lower heating plate temperatures of 100° C., a pressing force of 0.2 MPa, a vacuum time of 30 seconds, and a pressing time of 30 seconds. Back grinding evaluation of the obtained substrate workpiece was performed, and it was confirmed that there were no fractures or cracks in the substrate. In addition, no warpage was observed in the substrate after the back grinding evaluation. Evaluation of peeling of the support film layer of the substrate workpiece (TK7B) after being subjected to back grinding was performed, and it was confirmed that the support film layer can be peeled off.

### Example 42

The same operation as in Example 41 was performed except that the substrate workpiece (TK7) was changed to the substrate workpiece (TK1) obtained in Example 36 to give a substrate workpiece (TK8). Back grinding evaluation of the obtained substrate workpiece was performed, and it was confirmed that there were no fractures or cracks in the substrate, but warpage was observed in the substrate after the back grinding evaluation. Evaluation of peeling of the support film layer of the substrate workpiece (TK8B) after being subjected to back grinding was performed, and it was confirmed that the support film layer can be peeled off.

### Example 43

The protective film layer of the laminate film (TS1) for temporary bonding obtained in Example 30 was peeled off, and then the laminate film (TS1) for temporary bonding was dried at 250° C. for 10 minutes. The laminate film (TS1) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate to give a substrate workpiece (TK7). The lamination conditions were upper and lower heating plate temperatures of 100° C., a pressing force of 0.2 MPa, a vacuum time of 30 seconds, and a pressing time of 30 seconds. The obtained substrate workpiece was set on a grinder DAG810 (manufactured by DISCO Corporation), and the silicon substrate was polished to a thickness of 50 μm. The silicon substrate after grinding was visually observed, and it was confirmed that there were no fractures or cracks. Back grinding evaluation was performed, and it was confirmed that there were no fractures or cracks in the substrate. In addition, no warpage was observed in the substrate after the back grinding evaluation. Evaluation of peeling of the support film layer of the substrate workpiece after being subjected to back grinding was performed, and it was confirmed that the support film layer can be peeled off.

### Example 44

After the support film layer was peeled off in Example 36, the support film layer and the 6-inch silicon substrate were observed. As a result, it was confirmed that the adhesive layer was on the support film layer side.

### Example 45

After the support film layer was peeled off in Example 37, the support film layer and the 6-inch silicon substrate were observed. As a result, it was confirmed that the adhesive layer was on the support film layer side.

### Example 46

After the support film layer was peeled off in Example 38, the support film layer and the 6-inch silicon substrate were observed. As a result, it was confirmed that the adhesive layer was on the support film layer side.

### Example 47

After the support film layer was peeled off in Example 39, the support film layer and the 6-inch silicon substrate were observed. As a result, it was confirmed that the adhesive layer was on the support film layer side.

### Example 48

After the support film layer was peeled off in Example 40, the support film layer and the 6-inch silicon substrate were observed. As a result, it was confirmed that the adhesive layer was on the support film layer side.

### Example 49

After the support film layer was peeled off in Example 41, the support film layer and the 6-inch silicon substrate were observed. As a result, it was confirmed that the adhesive layer was on the support film layer side.

### Example 50

After the support film layer was peeled off in Example 42, the support film layer and the 6-inch silicon substrate were observed. As a result, it was confirmed that the adhesive layer was on the support film layer side.

### Example 51

After the support film layer was peeled off in Example 43, the support film layer and the 6-inch silicon substrate were observed. As a result, it was confirmed that the adhesive layer was on the support film layer side.

### Example 52

The adhesive coating material (CM1) obtained in Production Example 1 was applied to a support film layer (a PET film, thickness: 38 μm, surface energy: 25.4 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS1) for temporary bonding having an adhesive layer thickness of 20 μm. The protective film layer was peeled off, and then the laminate film (GS1) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was transferred to the 6-inch silicon substrate.

### Example 53

The adhesive coating material (CM1) obtained in Production Example 1 was applied to a support film layer (a PET film, thickness: 38 μm, surface energy: 30.3 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS2) for temporary bonding having an adhesive layer thickness of 20 μm. The protective film layer was peeled off, and then the laminate film (GS2) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was transferred to the 6-inch silicon substrate.

### Example 54

The adhesive coating material (CM1) obtained in Production Example 1 was applied to a support film layer (a PET film, thickness: 38 μm, surface energy: 14.7 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS3) for temporary bonding having an adhesive layer thickness of 20 μm. The protective film layer was peeled off, and then the laminate film (GS3) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was transferred to the 6-inch silicon substrate.

### Example 55

The adhesive coating material (CM1) obtained in Production Example 1 was applied to a support film layer (a Kapton film, thickness: 5 μm, surface energy: 69.4 mJ/m²) with a bar coater, and dried at 200° C. for 10 minutes. Then, SR7 (manufactured by OHTSUKI INDUSTRIAL CO., LTD.) was laminated thereon as a protective film layer to give a laminate film for temporary bonding having an adhesive layer thickness of 20 μm. The protective film layer was peeled off, and then the laminate film for temporary bonding was laminated on a copper substrate with a vacuum laminator CVP300T (manufactured by Nichigo-Morton Co., Ltd.) so that the adhesive layer would come into contact with the copper substrate. The lamination conditions were upper and lower heating plate temperatures of 120° C., a pressing force of 0.4 MPa, a vacuum time of 30 seconds, and a pressing time of 60 seconds. The obtained laminate was visually observed, and it was confirmed that no voids or peeling was found. In an inert oven in a nitrogen atmosphere, the obtained laminate was heated to 500° C. over 2 hours, held at 500° C. for 30 minutes, and cooled to room temperature over 2 hours. The obtained laminate was visually observed, and it was confirmed that no voids or peeling was found.

### Example 56

The adhesive coating material (CM1) obtained in Production Example 1 was applied to a support film layer (a PET film, thickness: 38 μm, surface energy: 43.3 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS4) for temporary bonding having an adhesive layer thickness of 20 μm. The protective film layer was peeled off, and then the laminate film (GS4) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was not transferred to the 6-inch silicon substrate, but was on the support film layer side.

### Example 57

The adhesive coating material (CM1) obtained in Production Example 1 was applied to a support film layer (a PET film, thickness: 38 μm, surface energy: 41.3 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS5) for temporary bonding having an adhesive layer thickness of 20 μm. The protective film layer was peeled off, and then the laminate film (GS5) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was not transferred to the 6-inch silicon substrate, but was on the support film layer side.

### Example 58

The adhesive coating material (CM1) obtained in Production Example 1 was applied to a support film layer (a polyimide film, thickness: 25 μm, surface energy: 69.4 mJ/m²) with a bar coater, and dried at 100° C. for 10 minutes. Then, SR7 (manufactured by OHTSUKI INDUSTRIAL CO., LTD.) was laminated thereon as a protective film layer to give a laminate film (GS6) for temporary bonding having an adhesive layer thickness of 20 μm. The protective film layer was peeled off, and then the laminate film (GS6) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was not transferred to the 6-inch silicon substrate, but was on the support film layer side.

### Example 59

The adhesive coating material (CM1) obtained in Production Example 1 was applied to a support film layer 140EN-Y (a polyimide film, thickness: 35 μm, surface energy: 71.9 mJ/m², manufactured by DU PONT-TORAY CO., LTD.) with a bar coater, and dried at 100° C. for 10 minutes. Then, SR7 (manufactured by OHTSUKI INDUSTRIAL CO., LTD.) was laminated thereon as a protective film layer to give a laminate film (GS7) for temporary bonding having an adhesive layer thickness of 20 μm. The protective film layer was peeled off, and then the laminate film (GS7) for temporary bonding was laminated on a 6-inch silicon substrate (thickness: 645 μm) with a vacuum laminator CVP300T (manufactured by Nichigo-Morton Co., Ltd.) so that the adhesive layer would come into contact with the silicon substrate. The lamination conditions were upper and lower heating plate temperatures of 120° C., a pressing force of 0.2 MPa, a vacuum time of 30 seconds, and a pressing time of 30 seconds. The support film layer was peeled off, and it was confirmed that the adhesive layer was not transferred to the 6-inch silicon substrate, but was on the support film layer side.

### Example 60

The adhesive coating material (CM1) obtained in Production Example 1 was applied to a support film layer (a Teflon (registered trademark) film, thickness: 100 μm, surface energy: 11.1 mJ/m²) with a bar coater, and dried at 100° C. for 10 minutes. Then, a Teflon (registered trademark) film was laminated thereon as a protective film layer to give a laminate film (GS9) for temporary bonding having an adhesive layer thickness of 20 μm. The protective film layer was peeled off, and as a result, a gap was formed between the adhesive layer and the support film layer in some region. In addition, for bonding with a vacuum laminator, the laminate film (GS9) for temporary bonding from which the protective film had been peeled off was placed on a 6-inch silicon substrate (thickness: 645 μm) so that the adhesive layer would come into contact with the silicon substrate. As a result, the adhesive layer was transferred to the 6-inch silicon substrate in a state where creases were formed in the adhesive layer.

### Example 61

The same operation as in Example 30 was performed except that the support film layer 140EN-Y was changed to Cerapeel HP2(U) (thickness: 75 μm, 1% weight loss temperature: 337° C., melting point: 259° C., a polyester film, manufactured by TORAY ADVANCED FILM Co., Ltd.) to give a laminate film (TS7) for temporary bonding having an adhesive layer thickness of 20 μm.

### Example 62

The same operation as in Example 30 was performed except that the support film layer 140EN-Y was changed to 7412K6 (thickness: 60 μm, melting point: 130° C., manufactured by TORAY ADVANCED FILM Co., Ltd.) to give a laminate film (TS8) for temporary bonding having an adhesive layer thickness of 20 μm.

### Example 63

The same operation as in Example 34 was performed except that the laminate film (TS1) for temporary bonding was changed to the laminate film (TS7) for temporary bonding obtained in Example 61 to give a substrate workpiece. The obtained substrate workpiece was left standing at 240° C. for 5 minutes, and then left standing at 280° C. for 5 minutes. As a result, the support film layer shrunk.

### Example 64

The same operation as in Example 34 was performed except that the laminate film (TS1) for temporary bonding was changed to the laminate film (TS8) for temporary bonding obtained in Example 62 to give a substrate workpiece. The obtained substrate workpiece was left standing at 240° C. for 5 minutes. As a result, the support film layer shrunk.

1-17. (canceled)

18. A laminate film for temporary bonding, comprising at least three layers of (A) a protective film layer, (B) an adhesive layer, and (C) a support film layer, wherein the adhesive layer (B) contains at least a siloxane polymer represented by the general formula (1) and a polyimide resin 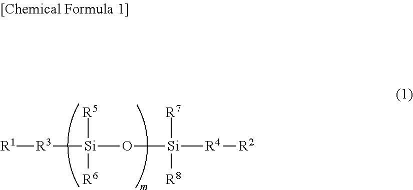
wherein m is an integer of 10 or more and 100 or less, R¹ and R² may be the same or different and each represent an amino group or a monovalent organic group represented by the general formula (4) or (5), R³ and R⁴ may be the same or different and each represent an alkylene group having 1 to 30 carbon atoms or a phenylene group, and R⁵ to R⁸ may be the same or different and each represent an alkyl group having 1 to 30 carbon atoms, an alkenyl group, an alkoxy group, a phenyl group, or a phenoxy group; or

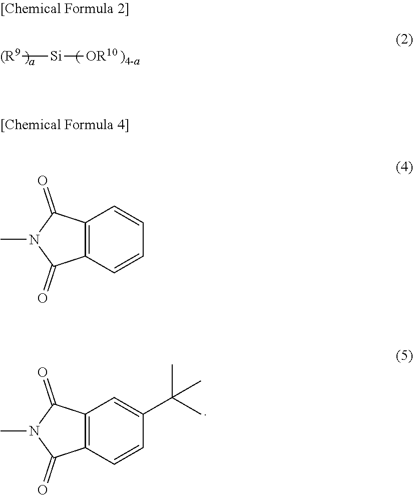

19. The laminate film for temporary bonding according to claim 18, wherein the polyimide resin contains a residue of a polysiloxane diamine represented by the general formula (3), and contains 60 mol % or more and 90 mol % or less of the residue of the polysiloxane diamine in all diamine residues: 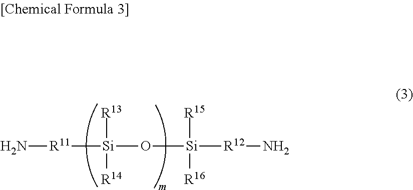
wherein n is a natural number, and has an average value calculated from the average molecular weight of the polysiloxane diamine of 1 or more and 100 or less, R¹¹ and R¹² may be the same or different and each represent an alkylene group having 1 to 30 carbon atoms or a phenylene group, and R¹³ to R¹⁶ may be the same or different and each represent an alkyl group having 1 to 30 carbon atoms, a phenyl group, or a phenoxy group.

20. The laminate film for temporary bonding according to claim 18, wherein the siloxane polymer represented by the general formula (1) accounts for 0.01% by mass or more and 30% by mass or less in components contained in the adhesive layer (B).

21. The laminate film for temporary bonding according to claim 18, wherein the adhesive layer (B) further contains inorganic fine particles.

22. The laminate film for temporary bonding according to claim 18, wherein the support film layer (C) has a thermal decomposition temperature of 200° C. or higher.

23. The laminate film for temporary bonding according to claim 18, wherein the support film layer (C) is a polyimide film or a polyphenylene sulfide film.

24. The laminate film for temporary bonding according to claim 18, wherein the support film layer (C) has a linear expansion coefficient of 10 ppm/° C. or less.

25. The laminate film for temporary bonding according to claim 24, wherein the support film layer (C) is a laminate of films each having a linear expansion coefficient of 10 ppm/° C. or less.

26. The laminate film for temporary bonding according to claim 18, wherein the support film layer (C) has a film thickness of 5μm or more and 300 μm or less.

27. A method for producing a substrate workpiece including the laminate film for temporary bonding according to claim 18, the method comprising the steps of:
peeling off the protective film layer (A), and
laminating the laminate film for temporary bonding from which the protective film layer (A) is peeled off on (D) a semiconductor circuit formation substrate with the adhesive layer (B) placed in between.

28. A method for producing a semiconductor device using a substrate workpiece produced by the method according to claim 27, the method comprising at least one of the steps of:
thinning the semiconductor circuit formation substrate (D),
subjecting the semiconductor circuit formation substrate (D) to device processing,
peeling off the support film layer (C) and the adhesive layer (B) from the semiconductor circuit formation substrate (D), and
washing off the adhesive layer attached to the semiconductor circuit formation substrate (D) with a solvent.

29. The method for producing a semiconductor device according to claim 28, further comprising, in the step of subjecting the semiconductor circuit formation substrate (D) to device processing, a step of heating the semiconductor circuit formation substrate (D) at 200° C. or higher.

30. The method for producing a semiconductor device according to claim 28, wherein the step of thinning the semiconductor circuit formation substrate (D) includes a step of thinning the semiconductor circuit formation substrate (D) to 1 μm or more and 100 μm or less.
